(19) United States
(12) Patent Application Publication
(10) Pub. No.: US 2023/0019995 A1
(43) Pub. Date: Jan. 19, 2023

(54) TROJAN DETECTION VIA DISTORTIONS, NITROGEN-VACANCY DIAMOND (NVD) SENSORS, AND ELECTROMAGNETIC (EM) PROBES

(71) Applicant: SRI International, Menlo Park, CA (US)

(72) Inventors: Michael Locasto, Lebanon, NJ (US); Bruce DeBruhl, Arroyo Grande, CA (US); Ulf Lindqvist, San Luis Obispo, CA (US); David Stoker, Menlo Park, CA (US); Ioannis Agadakos, Chicago, IL (US)

(21) Appl. No.: 17/866,243

(22) Filed: Jul. 15, 2022

Related U.S. Application Data
(60) Provisional application No. 63/223,374, filed on Jul. 19, 2021.

(51) Int. Cl. G06F 21/56; G01R 31/317; G01R 31/319

(52) U.S. Cl. CPC G06F 21/566; G01R 31/31703; G01R 31/31917; G06F 2221/034

(57) ABSTRACT

A method may involve applying, by a testing computing device, a distortion to a computing device under test. The distortion includes operating the computing device under test at a performance range of a computational resource that could cause the computing device under test to operate outside a normal range. The method may also involve receiving, by the testing computing device and in response to the applying of the distortion, one or more digital signals from the computing device under test. The method may further involve comparing, by the testing computing device, the one or more digital signals to one or more baseline digital signals associated with the computing device under test. The method may also involve detecting, based on the comparing, a presence of at least one anomalous element that could be indicative of a hostile element in the computing device under test.

### CROSS-REFERENCE TO RELATED APPLICATIONS

This application claims priority to U.S. Provisional Pat. Application No. 63/223,374, titled “Detection of Hardware Trojans via Distortions,” filed on Jul. 19, 2021, which is hereby incorporated by reference in its entirety.

### GOVERNMENT LICENSE RIGHTS

This invention was made with Government support under Agreement No. HR0011-20-9-0005, awarded by the Defense Advanced Research Projects Agency. The Government has certain rights in the invention.

### BACKGROUND

The offshoring of microelectronics processes poses a major risk for information technology (IT) systems, such as internet routers and computer servers, which use commercial- off-the-shelf (COTS) hardware. The supply chain is complex and an individual component can change hands multiple times, offering many opportunities for nefarious actors to introduce new components to hardware elements, for example, to a printed circuit board (PCB). Such malicious circuitry, or hardware Trojan, can remain hidden and avoid post-manufacturing tests until its functionality is triggered. The difficulty of detecting implanted hardware Trojans is compounded by an inability to compile test patterns for every feasible kind of Trojan. Currently, there are no desirably scalable, non-intrusive means to detect such hardware Trojans planted by advanced adversaries. As a result, such Trojans could render other security measures useless.

The opportunity for adversaries to covertly introduce hardware Trojans into modern electronic devices remains great. This exposes important missions to adversarial actions. There is a large network of software and hardware designers, manufacturers, and logistics companies involved with each electronic device. This has led to increasing concern regarding the security of the software and hardware supply chain and can have a significant impact on national security. There has been considerable interest in exploring ways to secure the supply chain from adversarial activity. Trojans may be inserted into software and hardware that could add side-channel communications, destroy or degrade hardware, and exfiltrate sensitive data. For example, there may be inappropriately recycled hardware, changes in passive components to slowly destroy hardware, and hardware modification at ports of entry. Software Trojans have been explored from microcode, firmware, operating system, libraries, and malicious developers. Hardware Trojans have been explored from Integrated Circuits (IC), printed circuit boards (PCB), and design software. Generally, it is desirable for a detection mechanism to be non-destructive, minimally invasive, scalable, reliable, and repeatable, so that systems can be scanned for possible dormant hardware Trojans, both prior to deployment, and repeatedly during deployment (e.g., to detect delayed-activation Trojans).

Methods of detecting PCB Trojans may be classified as destructive or non-destructive, and passive or active. Passive non-destructive techniques include visual inspection and thermal scanning. Such techniques can detect some changes to PCBs like additional traces on the outer layers or changes to ICs with visible markings. However, these techniques are less capable of detecting Trojans that include rerouting of internal PCB layers, alteration of passive components, or stealthily swapping ICs. Other approaches to detecting PCB Trojans have included active non-destructive scanning like terahertz and x-ray imaging. These techniques can improve detection of changes in internal PCB layers, but they are typically unable to detect passive component changes and stealthy swapping of ICs. An alternative approach is a traditional destructive hardware reverse engineering process. This process involves de-soldering the board, testing each component for correct performance, and testing electrical continuity of the PCB. This approach would be able to find most Trojans with limited exceptions. However, it has two major downsides. First, the process is destructive which means that one can only test a limited sample of boards, which then become unusable. Second, the process can be expensive and time consuming, reducing coverage to limited selected samples.

Accordingly, current safeguards against such hidden hardware Trojans rely on individual methods for monitoring behavior changes against a known good (golden) sample, and these methods, having been limited to single-thread environments, may not sufficiently scale to a complex commercial off-the shelf system (COTS) system. Visual inspection may be generally ineffective, and not scalable. Best-of-breed experimental alternatives rely on side-channel emanations such as radio frequency and electromagnetic signals to infer the execution of abnormal hardware or software logic.

### SUMMARY

In one aspect, a computing device may be configured to detect implanted hardware Trojans in a computing device.

In a first aspect, a computer-implemented method is provided. The method includes applying, by a testing computing device, a distortion to a computing device under test. The distortion includes operating the computing device under test at a performance range of a computational resource that could cause the computing device under test to operate outside a normal range. The method includes receiving, by the testing computing device and in response to the applying of the distortion, one or more digital signals from the computing device under test. The method also includes comparing, by the testing computing device, the one or more digital signals to one or more baseline digital signals associated with the computing device under test. The method additionally includes detecting, based on the comparing, a presence of at least one anomalous element that could be indicative of a hostile element in the computing device under test.

In a second aspect, a computing device is provided. The computing device includes one or more processors and data storage. The data storage has stored thereon computer-executable instructions that, when executed by the one or more processors, cause the computing device to perform operations. The operations may include applying, by a testing computing device, a distortion to a computing device under test. The distortion includes operating the computing device under test at a performance range of a computational resource that could cause the computing device under test to operate outside a normal range. The operations may include receiving, by the testing computing device and in response to the applying of the distortion, one or more digital signals from the computing device under test. The operations may also include comparing, by the testing computing device, the one or more digital signals to one or more baseline digital signals associated with the computing device under test. The operations may additionally include detecting, based on the comparing, a presence of at least one anomalous element that could be indicative of a hostile element in the computing device under test.

In a third aspect, a system is provided. The system may include one or more processors. The system may also include data storage, where the data storage has stored thereon computer-executable instructions that, when executed by the one or more processors, cause the system to carry out operations. The operations may include applying, by a testing computing device, a distortion to a computing device under test. The distortion includes operating the computing device under test at a performance range of a computational resource that could cause the computing device under test to operate outside a normal range. The operations may include receiving, by the testing computing device and in response to the applying of the distortion, one or more digital signals from the computing device under test. The operations may also include comparing, by the testing computing device, the one or more digital signals to one or more baseline digital signals associated with the computing device under test. The operations may additionally include detecting, based on the comparing, a presence of at least one anomalous element that could be indicative of a hostile element in the computing device under test.

In a fourth aspect, an article of manufacture is provided. The article of manufacture may include a non-transitory computer-readable medium having stored thereon program instructions that, upon execution by one or more processors of a computing device, cause the computing device to carry out operations. The operations may include applying, by a testing computing device, a distortion to a computing device under test. The distortion includes operating the computing device under test at a performance range of a computational resource that could cause the computing device under test to operate outside a normal range. The operations may include receiving, by the testing computing device and in response to the applying of the distortion, one or more digital signals from the computing device under test. The operations may also include comparing, by the testing computing device, the one or more digital signals to one or more baseline digital signals associated with the computing device under test. The operations may additionally include detecting, based on the comparing, a presence of at least one anomalous element that could be indicative of a hostile element in the computing device under test.

In a fifth aspect, a computer-implemented method is provided. The method includes measuring, by a nitrogen-vacancy diamond (NVD) sensor, a digital signal transmitted by a region of a printed circuit board (PCB) of a computing device under test for a presence of at least one anomalous element that could be indicative of a hostile element in the PCB. The method includes comparing, by a testing computing device, the digital signal to a device fingerprint associated with the computing device under test. The method also includes detecting, based on the comparing and by the testing computing device, the presence of the at least one anomalous element in the region of the PCB.

In a sixth aspect, a computing device is provided. The computing device includes one or more processors and data storage. The data storage has stored thereon computer-executable instructions that, when executed by the one or more processors, cause the computing device to perform operations. The operations may include measuring, by a nitrogen-vacancy diamond (NVD) sensor, a digital signal transmitted by a region of a printed circuit board (PCB) of a computing device under test for a presence of at least one anomalous element that could be indicative of a hostile element in the PCB. The operations may include comparing, by a testing computing device, the digital signal to a device fingerprint associated with the computing device under test. The operations may also include detecting, based on the comparing and by the testing computing device, the presence of the at least one anomalous element in the region of the PCB.

In a seventh aspect, a system is provided. The system may include one or more processors. The system may also include data storage, where the data storage has stored thereon computer-executable instructions that, when executed by the one or more processors, cause the system to carry out operations. The operations may include measuring, by a nitrogen-vacancy diamond (NVD) sensor, a digital signal transmitted by a region of a printed circuit board (PCB) of a computing device under test for a presence of at least one anomalous element that could be indicative of a hostile element in the PCB. The operations may include comparing, by a testing computing device, the digital signal to a device fingerprint associated with the computing device under test. The operations may also include detecting, based on the comparing and by the testing computing device, the presence of the at least one anomalous element in the region of the PCB.

In an eighth aspect, an article of manufacture is provided. The article of manufacture may include a non-transitory computer-readable medium having stored thereon program instructions that, upon execution by one or more processors of a computing device, cause the computing device to carry out operations. The operations may include measuring, by a nitrogen-vacancy diamond (NVD) sensor, a digital signal transmitted by a region of a printed circuit board (PCB) of a computing device under test for a presence of at least one anomalous element that could be indicative of a hostile element in the PCB. The operations may include comparing, by a testing computing device, the digital signal to a device fingerprint associated with the computing device under test. The operations may also include detecting, based on the comparing and by the testing computing device, the presence of the at least one anomalous element in the region of the PCB.

In a ninth aspect, a computer-implemented method is provided. The method includes measuring, by an electromagnetic (EM) probe, an EM radiation transmitted by a region of a printed circuit board (PCB) of a computing device under test for a presence of at least one anomalous element that could be indicative of a hostile element in the PCB. The method includes comparing, by a testing computing device, the EM radiation to a device fingerprint associated with the computing device under test. The method also includes detecting, based on the comparing and by the testing computing device, the presence of the at least one anomalous element in the region of the PCB.

In a tenth aspect, a computing device is provided. The computing device includes one or more processors and data storage. The data storage has stored thereon computer-executable instructions that, when executed by the one or more processors, cause the computing device to perform operations. The operations may include measuring, by an electromagnetic (EM) probe, an EM radiation transmitted by a region of a printed circuit board (PCB) of a computing device under test for a presence of at least one anomalous element that could be indicative of a hostile element in the PCB. The operations may include comparing, by a testing computing device, the EM radiation to a device fingerprint associated with the computing device under test. The operations may also include detecting, based on the comparing and by the testing computing device, the presence of the at least one anomalous element in the region of the PCB.

In an eleventh aspect, a system is provided. The system may include one or more processors. The system may also include data storage, where the data storage has stored thereon computer-executable instructions that, when executed by the one or more processors, cause the system to carry out operations. The operations may include measuring, by an electromagnetic (EM) probe, an EM radiation transmitted by a region of a printed circuit board (PCB) of a computing device under test for a presence of at least one anomalous element that could be indicative of a hostile element in the PCB. The operations may include comparing, by a testing computing device, the EM radiation to a device fingerprint associated with the computing device under test. The operations may also include detecting, based on the comparing and by the testing computing device, the presence of the at least one anomalous element in the region of the PCB.

In twelfth aspect, an article of manufacture is provided. The article of manufacture may include a non-transitory computer-readable medium having stored thereon program instructions that, upon execution by one or more processors of a computing device, cause the computing device to carry out operations. The operations may include measuring, by an electromagnetic (EM) probe, an EM radiation transmitted by a region of a printed circuit board (PCB) of a computing device under test for a presence of at least one anomalous element that could be indicative of a hostile element in the PCB. The operations may include comparing, by a testing computing device, the EM radiation to a device fingerprint associated with the computing device under test. The operations may also include detecting, based on the comparing and by the testing computing device, the presence of the at least one anomalous element in the region of the PCB.

### BRIEF DESCRIPTION OF THE FIGURES

FIG. 1 is a diagram illustrating an example detection system for hardware Trojans, in accordance with example embodiments.

FIG. 2 is a diagram illustrating an example detection system based on applying a distortion, in accordance with example embodiments.

FIG. 3 illustrates example experimental results for a detection system based on applying a distortion, in accordance with example embodiments.

FIG. 4 is a diagram illustrating an example nitrogen-vacancy diamond (NVD) sensor, in accordance with example embodiments.

FIG. 5 depicts a network environment for a device with a Trojan, in accordance with example embodiments.

FIG. 6 is a block diagram of an example computing environment for Trojan detection, in accordance with example embodiments.

FIG. 7A shows a block diagram depicting training and inference phases for an example machine learning model, in accordance with example embodiments.

FIG. 7B illustrates anomaly scores obtained using a generative adversarial network (GAN) model, in accordance with example embodiments.

FIG. 7C illustrates a joint distribution to compute anomaly scores, in accordance with example embodiments.

FIG. 8 is a block diagram of an example computing device including non-transitory computer-readable medium storing executable code for a distortion-based detection system, in accordance with example embodiments.

FIG. 9 is a block diagram of an example computing device including non-transitory computer-readable medium storing executable code for a NVD sensor-based detection system, in accordance with example embodiments.

FIG. 10 is a block diagram of an example computing device including non-transitory computer-readable medium storing executable code for an electromagnetic (EM) probe-based detection system, in accordance with example embodiments.

FIG. 11 illustrates a method for a Trojan detection system, in accordance with example embodiments.

FIG. 12 illustrates a method for a distortion-based detection system, in accordance with example embodiments.

FIG. 13 illustrates a method for a NVD sensor-based detection system, in accordance with example embodiments.

FIG. 14 illustrates a method for an electromagnetic (EM) probe-based detection system, in accordance with example embodiments.

### DETAILED DESCRIPTION

As described herein, unanticipated logic states of a combined Trojan and a target computing system may be leveraged to violate Trojan author assumptions and expectations about resources and host system behavior. For example, the Trojan may not have mature, robust error handling, or such code may be a source of bugs and/or unanticipated error. Attackers are generally configuring Trojans to reduce the Trojan’s footprint in order to escape defensive scanning mechanisms. Thus, including more functionality is a premium that attackers may hesitate to pay. Accordingly, an approach to anomaly-based intrusion detection as applied to the problem of hardware Trojan detection is described herein. In example embodiments, this approach involves obtaining a multi-faceted collection of distorted baselines. Generally, Trojan components are not designed to be passive activities; they have their own resource dependencies and assumptions about the operating environment. By initiating and focusing distortions on those properties and contending for those resources in multiple dimensions, a Trojan can be pushed to the edge of its operational capabilities and its impact on the enclosing system may be measured. In one aspect, a modeling approach described herein seeks to identify a method of automatically combining distortion techniques from different components, layers of abstraction, and modes of information to overburden the Trojan’s ability to lie simultaneously in many directions.

Accordingly, methods and systems are disclosed that weaken or violate assumptions that an attacker may make when placing anomalies or Trojans into systems, whether during design, manufacture (i.e., fabrication), patching, or maintenance. Generally, attackers make assumptions that can be exploited by cross-layer inconsistencies in information so that embedded Trojans reveal themselves by responding to probe packets containing such inconsistency. Furthermore, complex systems have hidden dependencies that can manifest in visible ways.

In some aspects, a mapping may be determined between a type of assumption an attacker makes in configuring a Trojan, and a type of distortion technique that can be applied to force the Trojan to reveal itself. As described herein, such an approach is agnostic to the presence of additional sensors, limits the need for invasive incursions into a computing chassis, and can permit detection and monitoring during normal workloads without disrupting a functioning of the computing device.

As used herein, the term “distortion” generally refers to operating device under test at a performance range of a computational resource that could cause the computing device under test to operate outside a normal range. For example, an inconsistency may be applied to various aspects of a hardware device, including, but not limited to, a configuration, a control, an input, and/or an output. For example, a distortion for a keyboard device may involve sending characters at a speed of the universal serial bus (USB) port that is within range of a maximum capacity, instead of the nominal human typing speed. By creating this distortion, a key logger Trojan may be detected because it is not designed to keep pace with an unexpectedly rapid character stream. The term “performance range” generally refers to a range of values for a computational resource at which the computational resource may be utilized at or close to an optimal performance capacity. For example, a memory resource may be close to saturation at a performance range, a processor speed may be at or close to a maximal speed, a battery power may be at or close to a maximal capacity, a size or a number of data packets in a network may be at or close to a maximum capacity of the network, a network bandwidth may be at or close to a maximal capacity. Generally, each computational resource is designed with a maximal performance capacity, and the performance range may be at or close to such performance capacity. In some embodiments, even though a computational resource may be designed to operate at a performance capacity, an actual performance range of the computational resource may be less, or more, than the designed performance capacity.

In some examples, a test can determine what the system does with such information, how it reacts to such information, and so forth. In some examples, a distortion can be applied to a control device (e.g., a device without a Trojan), and a device with a Trojan (“Trojaned” system), and any differences in response to applied stimuli can be measured. Such measurements can indicate a potential threat to a system, which can then be investigated further. Distortion enables subversion of the Trojan’s assumptions on external resources and/or state, and therefore disrupts its normal or expected performance parameters.

Trojan designers generally cannot anticipate a change in system resources, and a Trojan may not be configured to continue in normal mode of operation when such changes are applied. Generally, Trojans are designed to be quiet, and are not configured with robust error handling capabilities. For example, if a Trojan is programmed to write something to memory, and the memory is full, then the Trojan may not know what to do. Disrupting the Trojan’s expected behavior in such a way may make the Trojan reveal itself.

In some embodiments, a distortion can be applied in a plurality of ways. For example, one or more specifications of a system as designed may be modified. For example, a Trojan may be dependent on utilizing memory resources, and distortion may be applied to exceed a performance range of an available memory resources, thereby disrupting the Trojan’s expected behavior, and causing it to become detectable. As another example, a Trojan may be dependent on access to certain internal networks, buses, CPU, power resources, and so forth, and the distortion may be applied to exceed a performance range of such computational resources.

Generally, Trojans may be designed to perform a variety of different operations. For example, a Trojan can open a back door, misappropriate data, reveal system behavior, reveal network characteristics, collect and/or transmit device related information, communicate and/or establish a communication channel with a hostile actor, disrupt certain types of system activity, and so forth. Accordingly, different distortions can be implemented to disrupt and detect each different type of Trojan. Also, for example, a single hardware device, such as a server, can be subjected to a plurality of distortions.

Some methods of detecting a Trojan in hardware involve anomaly detection in networks. For example, in network anomaly detection, a stream of network packets may be monitored, and abnormal activity and/or behavior associated with the stream of network packets may be detected. Generally, existing systems are predicated on deriving a single, trained, high fidelity model of what is a normal or central behavior of a system. However, such an approach may not be effective with Trojans because Trojans are designed to hide within the normal mode of the system. Trojans are not designed to be visible within the parameters of what is an expected or normal functioning of the system.

In designing the one or more distortions, parameters indicative of a performance capacity (e.g., error cases or corner cases) of a system may be considered, and the distortion may be tailored to one or more such parameters. For example, a Trojan designer may be aware that such a performance capacity exists, but they may not be aware of how a system behaves in this performance capacity. As another example, although a Trojan designer may be aware of an error case or a corner case, the designer may be unaware of modifications to the error or corner case.

Also, for example, a Trojan may be injected in one step of a supply chain, and the Trojan designer or attacker may not have control over subsequent steps of the supply chain. For example, a chip may be inserted when a circuit board is designed. Later in the supply chain, the board with the chip may be paired up with other components. Accordingly, the designer of the Trojan may add a Trojan to the chip, but may be unaware of, or be unable to predict, later modifications. For example, a Trojan designer may not know what firmware will be used, or what the operating system may be. Generally, the designer of the Trojan may not be able to foresee the entire environment within which an injected Trojan may be expected to perform. As a result, the designer of the Trojan may not have a chance to test the system in its final configured state. Complex systems may behave very different when they are assembled together. Accordingly, a disruption can be configured to leverage such emergent behavior which is unknown to hostile actors.

Generally, at a center of normal behavior, a system with a Trojan and a normal system will likely overlap in their behavior, but at the error cases or corner cases, their behavior is likely to diverge. Thus, applying a tailored disruption may be based on disrupting and evaluating system behavior under a sufficient number of corner cases to deduce that a Trojan is present in the system. This is a departure from traditional techniques that focus on determining a characteristic of the Trojan, its signature, functionality, and so forth, and instead determining a deviation in a Trojan's behavior when it is subjected to conditions it is not configured to anticipate.

Once such deviation in behavior is determined, an alert can be generated, and the suspected device under test can then be taken off the shelf to perform additional investigations, such as with x-rays etc. to actually detect the Trojan. Thus, applying a distortion can involve using non-invasive techniques to identify a potential presence of a Trojan, and then following up with an invasive operation to detect and/or isolate the Trojan.

In some aspects, commercial benefits of such distortion techniques can be derived by a buyer of a system, a server, or a collection of server blades, and any user of such systems in a data center.

In some instances, a Trojan may be introduced in a chip during the manufacturing process, but the Trojan may be activated later, for example, by a firmware update. One challenge in Trojan detection is not knowing when it may be activated. Accordingly, disruption techniques may be applied at different points in time.

In one aspect, an OEM may apply disruption techniques before a device is shipped out from its facility. This could ensure that any already active Trojans are detected. Also, for example, this could provide assurances to a buyer that there was no indication of an active Trojan at the time the product was shipped. For example, a regulatory agency may establish a certification process that requires a manufacturer to certify that they have integrated various components and have successfully performed a distortion technique on the various components.

In another aspect, a buyer of a product may apply disruption techniques after a device is received. For example, a buyer may apply the disruption techniques at various intervals to detect inactive Trojans that are activated. For example, such disruption techniques may be applied when a firmware is updated, an external device is connected, and so forth. In one example implementation, a data center may have a configuration comprising rows and rows of server racks, and it may be beneficial to probe or scan the racks on a periodic basis. For example, a robotic device equipped with distortion applying strategies could probe and/or monitor the racks for potential threats.

Some embodiments involve determining a confidence level for the computing device under test, wherein the confidence level is indicative of a hostile element detected in the computing device under test. For example, a threat score may be determined based on a number of potential hostile elements in a system. Generally, when a distortion is applied, NVD sensing is performed, and/or EM radiation signals are analyzed, an anomalous element may be identified. However, such an anomalous element may not necessarily indicate a hostile component. Also, for example, some anomalous elements may be more indicative of a hostile component than others. Accordingly, the determining of the confidence level may involve applying respective weights to each of the at least one anomalous elements, wherein the respective weights are based on a type of hostile element. The confidence level may be a weighted average of the number of anomalous elements. For example, one or more distortion techniques may each be associated with a score, possibly weighted, that indicates a level of threat. In some embodiments, each device can be associated with an aggregated threat score indicative of a total threat to the device. Such embodiments may also involve determining, based on the confidence level for the computing device under test, one or more of a frequency of applying a distortion or a type of distortion to be applied to the computing device under test. For example, a type of distortion to be applied, and/or a frequency of applying distortion techniques, may be based on the aggregated threat score.

Often, Trojans are introduced in a motherboard (e.g., in a server). A number of components may be integrated together into the server. Some approaches to threat detection may focus on analyzing the circuit libraries that are in a particular chip, or memory, and so forth. Accordingly, each server motherboard may be viewed as an environment, and it may be determined as to how each component in that environment may distort each other.

In terms of non-invasive detection, there are various techniques involving radio frequency (“RF”) that can be used. For example, reverse engineering can be applied to determine what code is on a chip by listening to the electromagnetic (“EM”) emissions. In some instances, an antenna may be situated proximate to a device under test and the data may be analyzed to detect what instructions are being executed by the software code. In another aspect, EM analysis may be performed to detect whether there are modifications of firmware in the computer and if the computer is executing functions that are not expected. Accordingly, the disruption techniques described herein may be coupled with one or more such non-invasive techniques. For example, application of a distortion can cause the Trojan to react, and the EM emissions could be analyzed to detect the abnormal instructions being executed. Also, for example, the system can be measured to determine a deviation from its expected behavior.

Detecting Trojans in a printed circuit board (PCB) can be particularly challenging. As described herein, the approach of injecting distortions to operate the device at the edge of performance may be modified. For example, the distortions may involve writing memory at the maximum speed, that write general purpose input/output (GPIO) pins in rapid succession, or that stress the USB drivers. Also, for example, multiple side-channel measurement techniques may be leveraged, utilizing emerging technologies with improved sensitivity to subtle changes. For example, unique fingerprints may be generated for the target device. Small changes in resistance, capacitance, integrated circuit (IC) design, or trace impedance due to a Trojan being exposed by distortions may cause measurable differences that are detectable by sensors, thereby revealing the Trojan. In some aspects, localized measurements at multiple points may be performed to provide a robust set of data to identify possible PCB regions with Trojans and localize the threat.

As described herein, device signatures may be analyzed using multiple deep learning techniques. For example, a cognitive neural network may be used to assess the feasibility and set a baseline for the detection techniques. However, given the sequential nature of the data, recurrent neural networks with the addition of long short-term memory (RNN-LSTM) may also be used. The use of LSTMs allows for training data with varying delay in the initiation of time series data, and such a model works well for time-series data. Also, for example, generative adversarial networks (GAN) may be used as another signature analysis model.

In some embodiments, a Trojan communication interface is provided. For example, a Trojan USB port may be coupled with a dedicated USB man-in-the-middle hardware. This can be a custom-built piece of hardware. Creating hardware Trojans to test a detection device can be very challenging and time consuming. However, credible realistic representations of hardware Trojans may be used to configure a Trojan detection system. In some embodiments, the Trojan communication interface may be an Ethernet man-in-the-middle hardware that is utilized to intercept data transmissions over a network. In some embodiments, the Trojan communication interface may be a serial man-in-the-middle.

Some Trojan detection systems have used optical scans and computer vision to locate variations. However, such techniques are generally unable to find more nuanced changes such as changes in trace thickness, changes in resistor values, and so forth. Changes to trace thickness and/or passive components would likely cause nuanced changes to the board at the micro- and nano-amp level. To observe such changes, a nitrogen-vacancy diamond (NVD) sensing technology may be utilized. For example, small changes in resistance, capacitance, or trace impedance generally cause noticeable current changes that can be observed using NVD sensing. Also, for example, moderate changes in resistance, capacitance, integrated circuit (IC) design, or trace impedance due to a Trojan being exposed to distortions should cause measurable differences in an EM fingerprint. Such changes are noticeable when the device and respective circuits are active and operating in predictable patterns. However, the changes may be accentuated when the device is operating at an edge of its performance, or even in error modes.

Accordingly, by using distortions and measuring currents with NVD sensing and EM radiation, a representative set of PCB Trojans can be detected and classified, for example, using cognitive neural networks or other machine learning (ML) techniques.

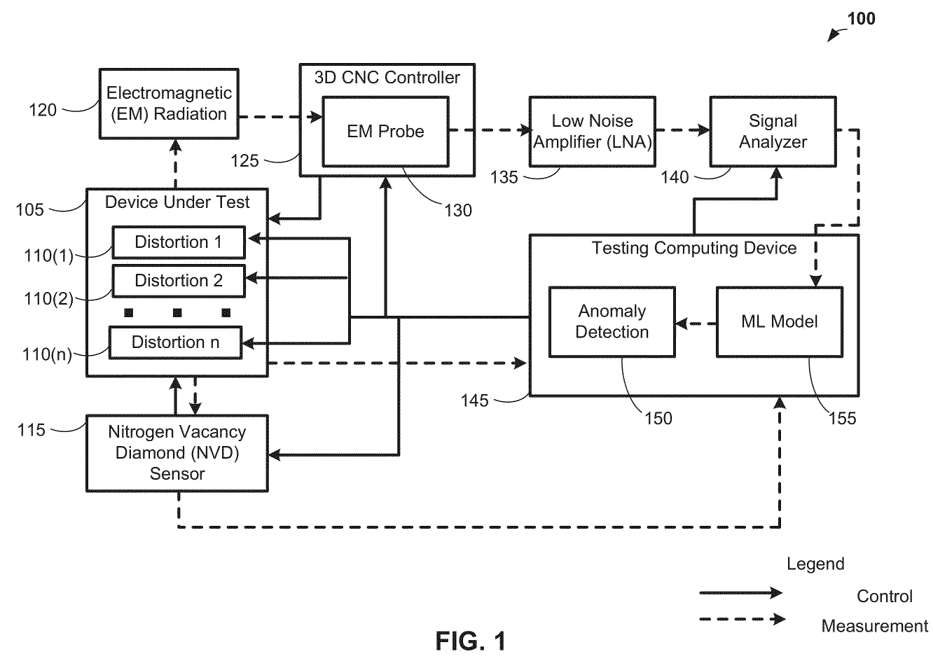

FIG. 1 is a diagram illustrating an example detection system for hardware Trojans, in accordance with example embodiments. In some embodiments, a distortion may be applied to a computing device such as device under test 105. The distortion involves operating device under test 105 at a performance range of a computational resource that could cause the computing device under test to operate outside a normal range. In some embodiments, one or more distortions, distortion 1 110(1), distortion 2 110(2), ..., distortion n 110(n), may be applied to device under test 105. For example, testing computing device 145 may apply the one or more distortions to device under test 105.

In some embodiments, NVD sensor 115 may be used to measure a digital signal transmitted by a region of a printed circuit board (PCB) of device under test 105 for a presence of at least one anomalous element that could be indicative of a hostile element in the PCB. For example, testing computing device 145 may cause NVD Sensor 115 to apply NVD sensing to device under test 105. In some embodiments, an EM probe 130 may be used to measure an EM radiation 120 transmitted by a region of a printed circuit board (PCB) of device under test 105 for a presence of at least one anomalous element that could be indicative of a hostile element in the PCB. For example, testing computing device 145 may cause EM probe 130 to apply EM radiation to device under test 105. In some embodiments, two or more of distortion 110, NVD sensor 115, or EM probe 130 may be used in combination to examine device under test 105.

As indicated by the “Legend,” a dashed arrow indicates a signal transmitted for measurement, and a solid arrow indicates a control signal.

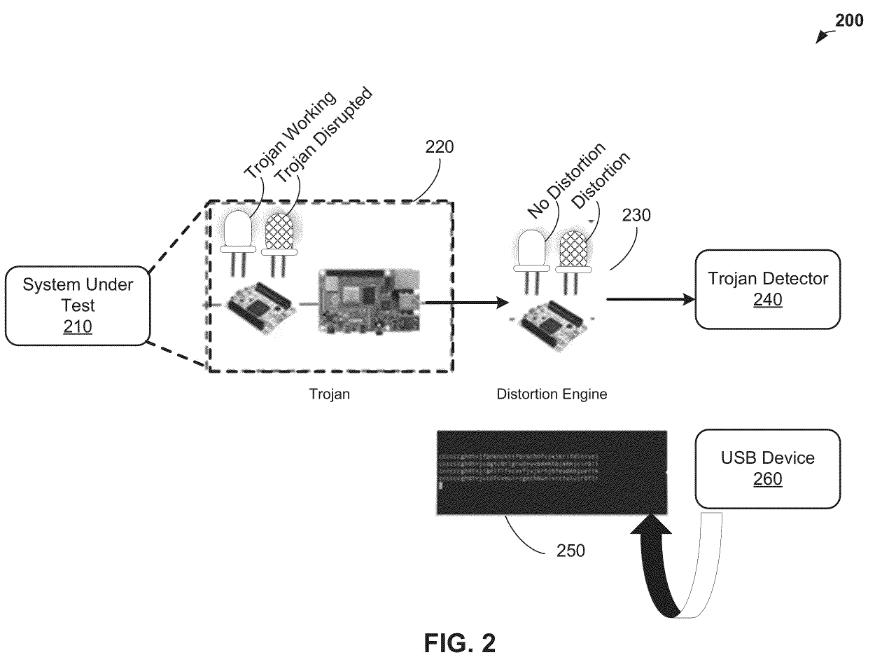

FIG. 2 is a diagram illustrating an example detection system 200 based on applying a distortion, in accordance with example embodiments. A system under test 210 (e.g., a server device) can be configured to include a representation of a hardware Trojan 220. A distortion engine 230 may be used to apply one or more distortions to the system under test 210, and a Trojan detector 240 may detect a presence of Trojan 220. In some aspects, Trojan detector 240 can be a hardware measuring device, and the distortion engine can be a hardware implant. In this example, a USB port of the system under test 210 may include a Trojan. The dashed box representing Trojan 220 may include two pieces of hardware - a Raspberry Pi and a special purpose a man-in-the middle hardware. Distortion engine 230 may be utilized to design custom USB protocol messages 250, essentially fuzzing the Trojan to reveal its behavior, when such activity is compared to an ideal or normal or expected USB port behavior. Generally, the term “fuzzing” as used herein, refers to a directed or undirected search through input space. This is different from a distortion, which is an inconsistency applied to a configuration or control or input.

The USB Device 260 (e.g., a YubiKey) is an example of a device and a type of information a Trojan can be configured to gather, and transmit to a host actor. Such a transmission can happen online, and the host actor may then take over a device, an account, a system, etc. even though a secured device, such as a YubiKey, is deployed. For example, Trojan 220 could be eavesdropping on a channel to discover authentication information input via a USB port of the system under test 210. The actual information may depend on the device attached to the USB. For example, instead of an external hardware device, the device could be a piece of storage. For example, the Trojan 220 could be rewriting the data, sending information, etc. based on the USB device.

In some examples, the USB Device 260, such as a YubiKey, which is essentially a secure keyboard, could be connected to the system under test 210, and Trojan 220 may be configured to behave like a key logger to eavesdrop on the data being transmitted, and/or or to rewrite traffic that is coming in, and/or store the data for access to confidential information. Generally, such techniques may be applicable to any compromised communications interface (e.g., a USB).

Assuming that Trojan 220 is performing such a function, a Trojan designer is likely to make assumptions about the system under test 210 to enable such functionality. Also, an active Trojan 220 may cause the USB port to function differently from a normal uncompromised USB port. One or more distortion techniques may be applied to modify and/or alter one or more USB specifications to challenge the assumptions made by the Trojan designer.

For example, the Trojan 220 may be made to believe that there are a large number (e.g., 2000) of keyboards. The Trojan 220 is configured to keep track of different devices that are logged in, just like at a normal port. So Trojan 220 is likely to include relevant logic to aid its information retrieval functions, such as, for example, is a particular device of interest, is it a particular keyboard that the Trojan needs to eavesdrop on, etc. Accordingly, Trojan 220 will be configured with some internal data structure, and some logical decisions that the Trojan has to execute to determine whether to access a device, what type of data to be interested in, how and when to transmit the data, how and where to store the data, and so forth. Therefore, one of the distortion strategies may be directed to overwhelm such data structures and/or configured logic. Another way to distort may be to supply the Trojan 220 with a large volume of data at a very high rate. This may induce Trojan 220 to copy all this data, and such additional activity to put the data in its own storage as well as pass it on through, may be detected. This is a kind of Trojan behavior under a distortion that can be fingerprinted by Trojan detector 240.

An example distortion technique may involve, for example, at step 1, a distortion engine 230 that analyzes the system under test 210. Distortion engine 230 may be in a first state when “No Distortion” is applied, and a second state when a “Distortion” is applied. At step 2, a distortion is applied and a delay in system performance may be detected. At step 3, Trojan 220 may be in an active state, and its activity may be disrupted by the distortion applied. At step 4, Trojan detector 240 may detect a potential presence of Trojan 220 based on measured deviations from normal behavior.

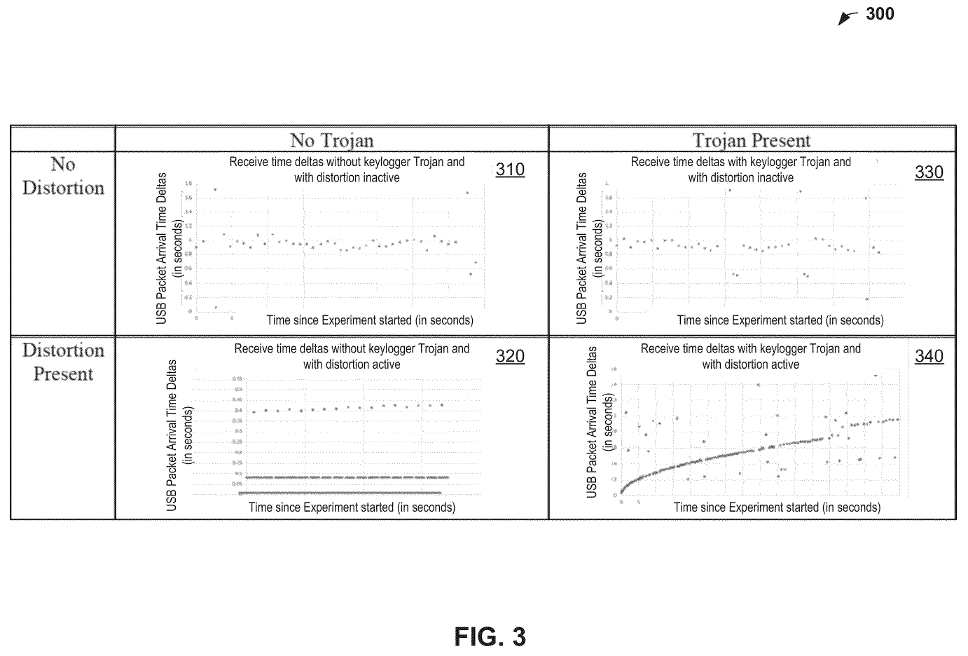

FIG. 3 illustrates example experimental results 300, in accordance with example embodiments. Four cases are illustrated, based on whether a Trojan is present or absent, and whether a distortion is present or absent. Graphs 310, 320, 330, and 340, represents each of the four cases. The horizontal axis of each graph represents time, measured from a start of the distortion experiment. The vertical axis of each graph represents jitter time, or delta values for USB Packet Arrival Times, measured in seconds. This corresponds to a jitter time when the USB packet arrives at the target USB port.

Graph 310 illustrates the case where there is no distortion and no Trojan. This may correspond to an ideal environment. Graph 320 illustrates the case where there is distortion and no Trojan. Graphs 310 and 320 show the ideal distributions in the absence of a Trojan. Similarly, graph 330 illustrates the case where there is no distortion and a Trojan is active. Graph 340 illustrates the case where there is distortion and a Trojan is active. Graphs 330 and 340 show the distributions in the presence of a Trojan.

As illustrated in graph 330, without a distortion, the presence of an active Trojan is not impacting the system. For example, if graph 330 is modeled with a linear regression, the result would be similar to graph 310, thereby incorrectly indicating that the system is in its ideal state.

Graph 320 illustrates that a distortion may not generally cause a disruption to a normal behavior of the system. For example, temporary distortions are not expected to adversely impact the system. However, frequent distortions may sometimes impact even a normal system, such as, for example, a data center. In graph 320, the dots represent that the system is responding very quickly to these key presses (from a USB keyboard). Some of the jitter time is very high, as expected. Nonetheless, the system handles high rate traffic without a problem and more importantly, continues its linear servicing behavior, as indicated by the dashed line.

Graph 340 reveals the Trojan’s logic. As illustrated, the logic is slowly becoming overwhelmed by the distortion being applied. An initial portion of the curve in graph 340 may be indicative of a normal keyboard input, and then a later portion of the curve in graph 340 may indicate that jitter continues to grow, thereby indicating that the Trojan functionality is progressively disrupted.

Referring back to FIG. 1, in some embodiments, a nitrogen-vacancy diamond (NVD) sensor 115 may be used to measure a digital signal transmitted by a region of a printed circuit board (PCB) of device under test 105 for a presence of at least one anomalous element that could be indicative of a hostile element in the PCB. A nitrogen-vacancy (NV) center is a defect in a diamond lattice where nitrogen and a vacancy replace two adjacent carbon atoms. An unpaired electron is trapped in the vacancy and forms an artificial atom. It is possible to excite the spin state of the negatively charged state with visible light at 532 nm, and photoluminescence from NV centers provides a way to read out spin states. Moreover, spin states can be manipulated with microwave pulses and the coherence time of an NV center can be as long as 2 ms even at room temperature. NV centers have the potential to be used in hybrid devices, and high-performance magnetic field sensors in a wide range of applications, including, among others, vector magnetic field sensing and magnetic field imaging. For example, static fields, dynamic AC fields, and vector magnetic fields (owing to the crystal asymmetries of the diamond lattice) may be sensed and imaged.

Hardware defect analysis can be a two-step process. First, nondestructive techniques can be used to localize faults. Subsequently, destructive methods (e.g., focused ion beam (FIB) imaging) may be used to cut into, or de-layer, a particular part to perform root cause analysis. It is preferable to gather as much information as possible in the first step, because the second step often cannot be undone. Non-destructive methods are at a premium because they are performed in their native environment. Destructive methods yield a superior spatial resolution but may reveal less functional information. Ideally, a sensor provides high bandwidth with high sensitivity and spatial resolution.

Many defects in modem ICs are ‘soft defects’. Soft defects generally refer to failures when the IC is partially functional, but will not operate under all conditions. Examples of soft defects include race conditions (e.g., mismatched arrival times of two gate inputs), soft gate-oxide breakdown (where carriers build up into the gate oxide and alter the transistor bias), resistive interconnects (shorts or opens appear after sufficient thermal expansion), and process variations. Hardware Trojans may be considered as a soft defect, since they occur in devices that operate normally under most conditions. An exception between hardware Trojans and soft-defects is that their design can incorporate stealth as a design parameter.

Magnetometry may be performed using devices such as a quantum interference devices (SQUIDs) and giant magnetoresistance (GMR). Both GMR and SQUID magnetometers may be scanned over a surface, and used as benchtop analytical tools instead of real-time anomaly detectors. Both SQUID and GMR-based sensors may be used for non-destructively detecting faults in PCBs, ICs, 3D stacked die, and other types of buried or laminated electronics, without direct electrical contact. NV diamond magnetometry offers high sensitivity, and with an advantage of a simple optical readout.

The sensitivity of NV diamond sensors derives from several factors, including broadening of atomic lines and flux concentration mechanisms at the sensor. With careful control of the NV diamond fabrication process, sub nanoTesla sensitivities may be achieved. For example, it is known that ferrite flux concentrators can significantly increase the sensitivity of magnetometers. Accordingly, combining picoTesla sensors with ferrite flux concentrators may extend NV Diamond into the sub picoTesla regime.

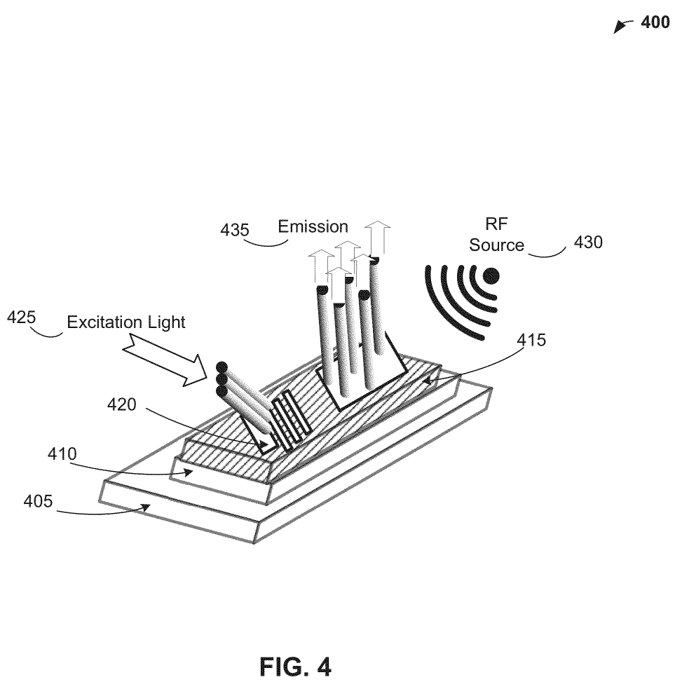

FIG. 4 is a diagram illustrating an example nitrogen-vacancy diamond (NVD) sensor 400, in accordance with example embodiments. PCB 405 includes IC chip 410. IC chip 410 is shown for illustrative purposes, and can be another feature of interest in PCB 405, and/or a passive device. NVD 415 can be an engineered diamond thin film that can be irradiated by nitrogen ions and then annealed, thereby creating an artificial atomic system. For example, NVD 415 can include an ensemble of NV centers located close to a main face. This active layer may be place in contact with a sample (e.g., IC chip 410), or any exposed chip on PCB 405. The atomic system can be excited by applying an excitation 425, for example, with green light that could have a wavelength of 532 nanometers. This causes emission 435 when IC chip 410 is exposed to a combination of things. For example, an RF source 430 may drive some changes in the artificial atomic system of NVD 415. In some embodiments, RF source 430 may be pulsed to apply varied time domain signatures.

The presence of a magnetic field, caused by current flowing within the device that IC chip 410 underneath that magnetic field, causes a change in the fluorescence that can be observed. Accordingly, by placing NVD 415 on top of a computer chip (e.g., IC chip 410), and then operating the computer chip, the areas inside of the chip that are active may be observed. For example, fiber-coupled excitation and detection signals may be collected and used to image the electrical currents in chips. For example, a mathematical relationship between the magnetic field that is created and the current inside IC chip 410, and the current density that creates the magnetic field can be used to analyze the electric currents. Also, for example, NVD 415 may be integrated in different ways. For example, excitation light 425 may be coupled into NVD 415, and have the light propagate along NVD 415 as a waveguide, using grating-coupled waveguide 420. Accordingly, excitation light 425 may be coupled through a fiber that then interacts with grating-coupled waveguide 420. The light can then be observed with a microscope. In some embodiments, a fiber bundle may be placed in direct contact with the surface so that the fluorescent light can be directed by an optical fiber to a sensor. In such an embodiment, NVD 415 may be integrated into a rig which may be dropped down to make contact with PCB 405. However, the sensor signals and may be channeled off to a computer. This can eliminate a need to collect the light or send lasers, as the light is contained inside the test apparatus.

Referring again to FIG. 1, in some embodiments, NVD sensor 115 can be applied directly to device under test 105, as described with reference to FIG. 4. In some embodiments, NVD sensor 115 can be applied in combination with the one or more distortions, distortion 1 110(1), distortion 2 110(2), ..., distortion n 110(n).

In some embodiments, the comparing of the one or more digital signals to the one or more baseline digital signals comprises detecting a change in a thermal measurement by detecting, by the NVD sensor, a shift in a photoluminescence central frequency toward a lower frequency, wherein the shift is indicative of a change in the thermal measurement to a higher temperature. For example, NVD sensor 115 may also detect thermal changes, and can be a useful multimodal sensor application. Temperature sensing with NV centers (e.g., NV centers of NVD 415 of FIG. 4) can be achieved with precision as good as approximately 0.2 K. Generally, the photoluminescence central frequency shifts toward lower frequency at higher temperatures. Alternatively, temperature dependence may be directly read out from the RF sweep frequency. The RF sweep shifts the zero-field mₛ = 0 and mₛ = ±1 spacing, but does not affect the Zeeman mₛ = +1 and mₛ = -1 splitting. Thus, the magnetic field and the temperature of device under test 105 may be determined by examining an intensity of the photoluminescence spectra as the RF frequency is swept. Accordingly, current and temperature information may be extracted simultaneously and independently from the intensity variations in the photoluminescence spectra. When a dormant Trojan activates, it is likely to consume power, and therefore reveal an increased heat signature at the location of the Trojan compared to normal PCB operation. In some embodiments, a temperature map of a printed circuit board (PCB) may be generated. Also, the detecting of the presence of the at least one anomalous element involves comparing the generated map with a density map for a flow of current in the PCB. For example, a temperature map of the PCB can be generated and compared to the current density map to pinpoint the location of the Trojan element. To reduce the form factor of an imaging system, geometries similar to that shown in FIG. 4 may be fiber-coupled. Similar fiber-coupled arrangements may be used with picoTesla sensitivity.

In some embodiments, an electromagnetic (EM) probe may be used to measure an EM radiation 120 transmitted by a region of a printed circuit board (PCB) of device under test 105 for a presence of at least one anomalous element that could be indicative of a hostile element in the PCB. A three-dimensional computer numerical control (CNC) controller 125 may include one or more EM probes 130. For example, electronic test vectors may be applied to a chip, which may cause a change in digital signatures such as a clock frequency of the chip. The one or more EM probes 130 may be connected to CNC controller 125 to obtain measurements at different points on a PC. For example, instead of having a single point on the PCB, a reasonably high certainty of detection may be achieved by examining locations across the PCB. 3D CNC controller 125 generates a 2D grid of measurements across the board or 2D specific points of measurements across the board.

In some embodiments, the EM radiation may be compared to a device fingerprint associated with the computing device under test. For example, a single point EM measurement on the corner of a processor or FPGA may be used to detect many different changes, including system hardware changes. The number of points of measurement may be increased to localize potential Trojans. Choosing locations on the PCB that may be likely targets for a Trojan is also likely to facilitate detecting the Trojan. Furthermore, by tightly controlling the corner operating conditions of the processor, memory, and other peripherals, stealthy Trojans that may not be seen with noisier processes (e.g., processor, NIC, RAM writes, etc.), may be detected.

As illustrated in FIG. 1, a combination of disruption and measurement may be used to detect a Trojan. For example, disruptions expose a Trojan by creating operational corner cases near the failure point of the default equipment. Also, for example, authenticating localized measurements using NVD sensing and EM may be used. Using the latest in deep learning, disruption responses may be classified into nominal or anomalous behaviors. For example, a support vector machine (SVM) may be used to classify the nominal or anomalous behaviors.

In some embodiments, low noise amplifier (LNA) 135 may be used to magnify the signal so that a reasonably high signal may be generated. Such a signal may be provided to signal analyzer 140.

The implementation can leverage a central testing computing device 145 that can automate injecting disruptions and associated measurements. The EM probe 130 may be selected according to the clock rate of the device under test 105, and attached to a 3-Axis CNC controller 125. The CNC controller 125 may step in the X and Y axes to measure EM radiation emanating from the device under test 105 in a grid. At each point, the device can be reset, and the one or more distortions 105(1), ..., 105(n) may be injected into the device. By having spatial and spectral resolution a high-fidelity performance measure of device under test 105 may be obtained.

Device fingerprints may be generated by applying machine learning models 155 (e.g., deep learning models). For example, a convolutional neural network (CNN) may be used to assess the feasibility and set a baseline for the detection techniques. Also, for example, given the sequential nature of the data, recurrent neural networks (RNN) with the addition of long short-term memory (RNN-LSTM) may be utilized. The use of LSTMs allows for training data with varying delay in the initiation of time-series data.

In some embodiments, generative algorithms based on deep adversarial networks may be used. The system architecture may be comprised of a front-end transformer network, followed by a generative adversarial network. A deep network may be trained on multi-sensor data to produce a noise-generated example of data consistent with prior measurements. The transformer network allows a single network to train for many driver conditions (in this case, driver conditions could be different instructions or operations carried out by the PCB). Repeated generation of data produces a statistical distribution, given some driver conditions. Anomaly detection 150 may involve comparing new data to the historical distributions, thereby enabling a generalized anomaly and Trojan detection platform that is not limited to any class of Trojan types. Although illustrative examples are based on a single PCB, the techniques may be extended to multiple PCBs.

In another aspect, described herein is a method of injecting hardware primitives that support greater non-determinism into circuit behavior. This can enable circuits to be designed in a fashion that contemplates and supports the deliberate application of distortion states. Generally, computer hardware environments offer a high degree of predictability to attackers, especially those who make use of hardware Trojans. Accordingly, design-supported distortion serves as a countermeasure to increase a complexity of a hardware Trojan and undermine assumptions a Trojan designer may make about a runtime state of the hardware component.

It may be challenging to increase an amount of unpredictability of hardware behavior. Traditional approaches to increasing trust in systems leverages multiple different implementations to provide fault tolerance of results. This kind of Byzantine robustness is more applicable to dependable systems engineering rather than detection of an adversary. While the research literature has suggested using extra circuitry in FPGAs (e.g., vote-and-compare to counter Trojans that attempt to weaken or subvert a particular computation), or in the die components themselves as a type of fingerprinting or detection mechanism, there does not appear to be a kind of informed probing detection approach as described herein.

Apart from a compromised communications interface, distortion techniques can be applied to baseboard management controller (BMC) Trojans. In particular, a network interface card (NIC) that has support for a baseboard management controller (BMC) control channel via its NC-SI functionality, can be subjected to distortion techniques to identify a potential presence of a Trojan.

As described, disclosed methods inject a plurality of sources of uncertainty into basic circuit operation, such as multiple notions of a valid clock, thereby offering multiple potentially valid circuit values to an observer, such as a Hardware Trojan. In some aspects, a circuit design is described that creates (from an adversary’s perspective), a Byzantine unreliable circuit. In other words, a circuit in which there are a number of possible correct answers to observation queries. A similar scheme may be implemented on the hardware level to act as a sieve separating intended components from malicious ones that have been implanted at some part of the manufacturing process.

In one example, Trojan construction and detection for an NIC device is described. A wide set of system parameters can be identified that can be used to distort the operation of a potentially Trojaned device.

Techniques disclosed herein can be applied systems that have high levels of hardware complexity (e.g., including collections of CPUs and microcontroller unit (MCU) contexts in excess of 32 and 128). These techniques can be applied to firmware and/or policy-based Trojans in NICs, and firmware Trojans in built-in BMC chips.

### Example Types of Trojans

A few example Trojans and their operational assumptions are outlined. For example, a “Bit” Trojan can be configured to rewrite packet data on packets destined for the host, so that the host only sees the modified version. To accomplish this, the Trojan can use an Application Processing Engine (APE), for running “value-add applications” beyond minimal NIC functionality, such as remote management of a host in coordination with a BMC. The APE may have its own memory and registers, but may share peripherals and resources with the rest of the device, notably shared memory (e.g., host kernel/NIC shared memory (SHM)). Target traffic may be selected using configurable hardware management filters, which copy traffic matching configurable patterns into a buffer controlled by the APE. Typically, the management filters may be used to select packets bound for the host machine’s BMC, allowing remote management traffic and ordinary host traffic to flow in parallel over the same Ethernet port. The management filter capability may be abused to send any traffic destined only for the host OS to the APE. Filter rules can be written to select based on any packet data content. For example, packets may be selected based on a target source IP address range.

Once filtered target packets are copied into the APE buffer, the APE calculates the changes to make to the packets, such as the edited flag word containing the set Reserved Bit, and the updated IPv4 header checksum. To pass the modified packet up to the host, the APE acquires the SHM buffer descriptor (BD) corresponding to the target packet and writes the changes to that buffer. This technique can be used by all following Trojans which modify or hide traffic intended for the host operating system (OS).

Generally, a Trojan may depend on an ability to modify the code running on the APE, including setup code for modifying the management filters, and main loop code, which maliciously modifies select packets. While it is possible to modify the device code at runtime, an attacker would likely modify the flash contents after a factory firmware has been flashed, and before end user installation of the card.

In a typical enterprise network configuration, an application server exists behind at least one dedicated firewall device responsible for rejecting traffic unrelated to the application being served. In addition to a discrete firewall, the application server will typically have an additional software firewall to limit the operating system’s exposure to any traffic that manages to traverse the external firewall. Such application servers are configured to reject inbound traffic unrelated to their application if it does not originate from a trusted source. Planting an “IP Proxy” Trojan on the application server machine’s NIC has the potential to facilitate internal network traversal that would normally be stopped by the application server firewall, because any traffic intercepted by the malicious NIC can be hidden from the host. The Trojan can exploit this to receive simple commands and data on the compromised NIC itself, which can be instructed to actively collect information on and traverse the internal network, exploiting trust placed in the host machine behind the primary firewall.

For example, an “IP Proxy” Trojan can be configured to listen for command packets in the form of HTTP-over-TCP that contain a bogus HTTP user agent string containing commands for a malicious NIC. In one embodiment, HTTP user agent packets are selected for command carrier operations because strict application-level packet filtering is rarely used in discrete firewalls, and because such packet filtering may be parsed by the “IP Proxy” Trojan with the help of the NIC management filters. Such a Trojan can assume the ability to modify APE code. In addition, for example, it can assume a firewall configuration on the target network that permits HTTP packets to reach the host on which a compromised NIC is installed. While it is not necessary to function, the “IP Proxy” Trojan may need other reachable devices on the network (i.e., on the same VLAN, or reachable across any firewalls) to accomplish its practical goal.

Another Trojan is a “credential grabber” Trojan that can use the APE’s ability to spy on all traffic passing through the NIC to the host, thereby compromising client and server data confidentiality. This Trojan is a special case of packet snooping, parsing, storage, and exfiltration, but the technique is useful for collecting any packet contents that stateless packet processing is able to identify and extract. To limit the packet processing load on the APE, the candidate packet space can be reduced in hardware using the APE’s configurable management filters. From the filtered candidate packets, credentials may be selected with a string search on HTTP data for confidential key and key hash form fields. Data can be written to a small ring buffer in the NIC NVRAM, the 512kB flash storage chip where device code is stored. Accordingly, when the compromised NIC receives a HTTP command packet from a control server, the collected data is loaded from the NVRAM and may be covertly exfiltrated by the Trojan to a command server using DNS. Such a Trojan is configured to assume the attacker’s ability to modify APE code as in the other Trojans. It is also configured to assume that the target host can receive inbound HTTP over TCP and send DNS requests for a domain under a malicious actor’s control. While a similar Trojan could be conceived to grab any sparse packet contents, “credential grabber” Trojan assumes that interesting credentials or hashes thereof may appear with a recognizable HTTP form field label.

Another example of a Trojan is a NIC Botnet for DDoS. For example, given control of the code running on the APE, a Trojan controller can send arbitrary packets from the NIC without the direct knowledge of the host. An ability of the NICs to send traffic directly without incurring the latency associated with generating traffic on the host OS, paired with the gigabit internet uplinks often available to servers, makes certain NICs an attractive tool for DDoS attacks. The NIC-resident DDoS Trojan attempts to register with a server using DNS tunneling once the NIC comes online. Once registered, the Trojan can listen for commands from the server. Upon receiving a ’start DoS‘ command packet containing a target IP address from the server, the Trojan bombards the target with unwanted IP traffic until a similar ’halt DoS' command is received. This Trojan assumes the ability to modify APE code as in the other Trojans. It also assumes that a large number of infected cards will come online and successfully register with the C2 server, such that the botnet formed is large and powerful enough to be useful.

### Example Distortion Techniques

An NIC can be a sophisticated, high-speed, modern network interface. The NIC may include several elements that support traffic inspection and would provide attractive footholds for hardware Trojans. The NIC contains an APE, which is an ARM-based CPU that runs separate firmware. It also contains a per-port RISC (MIPS) processor that provides the capability to inspect and modify traffic. The NIC also interacts with DMA over the PCIe bus.

One or more distortion techniques can be applied to a hardware Trojan on an NIC, such as, for example, resetting or disabling the Memory Arbiter, modifying the parameters of the Host Coalescing Engine, fingerprinting the DMA Buffer operation, and/or modifying the Watchdog Timer bounds. Additional and/or alternative techniques may be applied in various aspects, including documented differences between prior revisions of the card, reserved state bits, static resource thresholds based on profiling or simulation, hardware offload of checksum calculation. Our procedure for identifying these is essentially a census of the various notes and restrictions stated in the programmer’s guide. Such notes either state explicit assumptions about prohibited or risky settings, or hint at a particular implementation that can be profiled and tested for additional logic or state. The architectural description and programmer’s guide can suggest a plurality of points at which the behavior of the NIC can be distorted outside normal operating parameters. Such behavior can be related to, for example, Interrupt coalescing, iteratively tightening the bounds of watchdog timers, TCP/IP packet fragmentation and TCP state explosion, TTL manipulation, injection of honey tokens, and/or cryptographic packaging.

Deep-packet inspection based on protocol interpretation can be fragile or may require a significant amount of replicated hardware state to decide in parallel which multi-layer interpretation is correct. Thus, additional distortion strategies may include wrapping IPv4 in IPv6, wrapping IPv4 in transparent (AH-only) IPsec packets (e.g., unwrapped by a software implant and re-delivered on a localhost). As another example, a TCP state explosion attack may be initiated by offering many competing window segments (and easily control which survive the card by setting low TTL values).

Also, for example, a Trojan variant may put a card in open mode by default, but may fail to advertise it up to the OS. The Trojan may not touch the PROMISC flag but may merely avoid turning it on. In such an instance, a distortion technique may involve sending layer 2 and 3 combination packets, addressed differently at each layer. A promiscuous card would collect these frames, bypassing the unicast hardware filtering in the NIC’s MAC management. These frames would be passed to the OS as layer three packets, where they would be delivered to the host kernel (since the destination IP address matches) and delivered either to a target software implant or be responded to by the host kernel.

Although an input to a Trojan may be manipulated to make the Trojan reveal itself, another distortion strategy may be to alter the behavior and properties of a NIC. For example, RX/TX ring parameters may be modified. As another example, the hardware assist for TCP/IP stack may be enabled and/or disabled. Also, for example, frame count and time coalesce parameters may be modified. In some embodiments, hardware components may be reset. Additionally and/or alternatively, one or more operating system networking parameters may be manipulated, such as, for example, parameters listed in “sysctl” tunables and/or “/proc” control of network global parameters.

### Distortion With “Byzantine Unreliable” Circuits

In some aspects, distortion techniques may be incorporated into a circuit. For example, hardware primitives may be injected into circuit behavior to support greater non-determinism, thereby thwarting a Trojan’s assumptions. For example, circuits may be designed in a fashion that contemplates and supports the deliberate application of distortion states. Such design-supported distortion serves as a countermeasure to increase the required complexity of a hardware Trojan and undermine assumptions it makes about the runtime state of the hardware component.

In some embodiments, the computing device under test may be configured with a Byzantine circuit comprising a predetermined distortion pattern to cause a synchronization skew, and wherein the detecting of the presence of the at least one anomalous element comprises one or more of detecting a malfunction of the computational resource or an error in a processing task performed by the computational resource. For example, a Byzantine unreliable circuit (unreliable from an attacker’s perspective) may be generated that is configured to comprise of a number of possible correct answers to observation queries. The Byzantine unreliable circuit may be implemented at a hardware level to act as a sieve separating intended components from malicious ones that have been implanted at some part of the manufacturing process. For example, along with a normal information traffic between parts of a system, a predetermined distortion pattern may be introduced that causes synchronization skew. As a result, unintended components inserted as Trojans will be unable to observe the correct data transfer and will either malfunction or they will be detected as the outcome of their processing will be erroneous.

An example circuit may be configured that performs computations for different clock cycles. Generally, an exact period that a clock ticks in a system is a secret. The Trojan may be configured to sample an output line (e.g., an output of gates) at a rate at which a Trojan designer may expect the clock’s period to be. However, such asynchronous sampling may cause the Trojan to read an incorrect value for the bit (e.g., read a “0” instead of a “1”, and vice versa). This is an example implementation of how support for distortions can be built into the hardware.

In some embodiments, a key synchronization scheme may be implemented, where malicious components have to register with a secret distribution service or include additional circuitry to snoop on a legitimate exchange (which could be made difficult with PUF-based communications). While altering the clock might seem simple and innocuous, it reveals a Trojan based on a potential for a detrimental effect on computation as it alters the information content observed by a circuit.

For example, a Byzantine circuity may comprise two 5-bit adders where a first adder is in possession of a secret pattern that allows the first adder to correctly observe the outputs of the counters. In contrast, a second adder, that has a circuit identical to the circuit of the first adder, does not have access to the required pattern, and thus fails to interpret the output of the counters. Its output is thus always invalid (e.g., “0”). Generally, circuits of any complexity are fundamentally sensitive to synchronization issues. In fact, the simplicity of adding an FSM style clock arbiter that alters the perceived clock based on a known pattern is a simple circuit that can augment any component.

### Example Measurement Techniques

As described, a plurality of system properties may be perturbed by applying one or more distortion techniques. Changes in system properties may be delivered from different vantage points in the system stack or privilege levels, both internal and external. For example, a software implant may be utilized. In some embodiments, the software implant may comprise one or more logical parts, such as, a measurer to measure a baseline property, a reporter to compare the baseline with an observed property, and a distorter. The distorter may be configured to apply one or more distortions according to a schedule, and/or a distortion policy. The software implant may be configured to perform various functions, such as, create data files for transmission; initialize services and/or servers; provide background data for measurement purposes; Honeytoken receptors; modify NIC parameters; modify OS-level network control parameters; collect, read, and/or poll NIC properties from the NIC and from the OS; measure and/or analyze timing and other baseline elements; compare to baseline, issue alerts if needed; transmit outbound network traffic distortions; and so forth.

In some embodiments, a configuration or policy file governing the selection, scheduling, and operation of distortions may be generated. For example, the configuration file may be a mapping of property names to policies. In particular, a construct {property_name} : {policy} can express a rule in an overall Distortion Strategy, where a policy is a value and rate, and those rules form sequences of manipulations of the properties of the various components in the devices under test.

In some embodiments, a network statistics tool can be used to periodically collect measurements on a system under test, such as an NIC. Parallel-coordinates graphs may be utilized to visualize multi-dimensional data. In some embodiments, each line of the multi-dimensional data may represent one of 100 snapshot vectors with each horizontal position containing a different dimension of the vector. As the magnitudes of some dimensions differ greatly, so the values may be normalized.

In some embodiments, detection of a Trojan may be associated with a confidence score. For example, a probability of detection may be determined that is indicative of an average number of successes in detecting a Trojan, where the score is averaged over multiple scans of the system under test. For example, the probability of detection may indicate “detects a firmware Trojan operating on the system under test four out of every five distortion-based scans.”

Another qualitative metric to determine a success of a distortion technique may be to determine a rate of false alarms. In order to avoid expensive, manually-driven examination of circuit-level logic, a false positive rate lower than 1 in 1000 scans or units examined may be considered as a threshold rate. Also, for example, latency may be measured to determine a time from a start of a scan to an end of the scan. Latency below a certain threshold may be indicative of a high quality distortion technique. As another example, a performance impact on a system may be measured. For example, a distortion technique may cause a high performance impact for a short duration of time, and/or may cause a high slowdown for an extended period.

### Network Environment

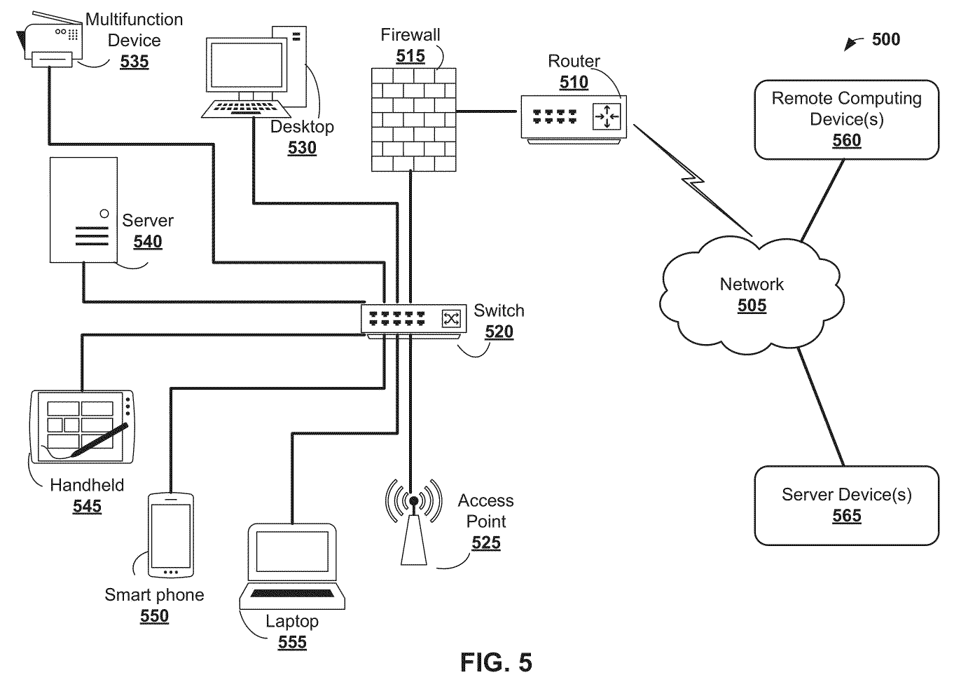

FIG. 5 depicts a network environment 500 for a device with a Trojan, in accordance with example embodiments. Network environment 500 includes network 505, remote computing device(s) 560, and server device(s) 565, that are configured to communicate, via network 505, with one or more devices such as a desktop 530, a multifunction device 535, a server 540, a handheld device 545, a smart phone 550, and/or a laptop 555.

Network 505 may correspond to a local area network (LAN), a wide area network (WAN), a WLAN, a WWAN, a corporate intranet, the public Internet, or any other type of network configured to provide a communications path between networked computing devices. Network 505 may also correspond to a combination of one or more LANs, WANs, corporate intranets, and/or the public Internet.

The network environment 500 may include tens, hundreds, or thousands of devices. In some examples, the one or more devices can be directly connected to network 505. In other examples, the devices can be indirectly connected to network 505 via router 510, firewall 515, network switch 520, and/or access point 525. In this example, router 510, firewall 515, network switch 520, and/or access point 525 can act as an associated computing device to pass electronic communications between the one or more devices and network 505. Although an example physical topology of network 505 is illustrated in FIG. 5, it is understood that network 505 may be associated with a logical topology for data flow between physical components of network 505.

Router 510 can be configured to transmit packets by processing routing information included in a packet (e.g., Internet protocol (IP) data from layer 3). The routing information can be processed via a routing table. Firewall 515 is a network device that can be configured to control network security and access rules. Network switch 520 can be a single switch or an array of switches. Switch 520 is a network device that can be configured to connect various devices on a network, such as, for example, desktop 530, multifunction device 535, server 540, handheld device 545, smart phone 550, and/or laptop 555. Switch 520 can use packet switching to receive and forward data between devices in a network. Access point 525 is a network device that can be configured to provide wireless access to various devices on the network.

Server devices 565 can be configured to perform one or more services, as requested by the one or more devices. For example, server device 565 can provide content to the one or more devices. The content can include, but is not limited to, content available over the World Wide Web (WWW), content from a dedicated server, software, images, audio, and/or video. The content can include confidential information. Although server 540 is shown as a single server, it can represent a plurality of servers, and/or a data center comprising a plurality of servers.

In some embodiments, remote computing device 560 can be a monitoring and/or management device that monitors and/or manages a hostile hardware component that has been installed in one or more devices (e.g., desktop 530, a multifunction device 535, a server 540, a handheld device 545, a smart phone 550, and/or a laptop 555). For example, during a manufacturing process for a motherboard installed in a device, a hostile actor may have installed a Trojan in the motherboard. In some embodiments, the Trojan may be activated after the device is assembled and a complete system is configured. Once activated, the Trojan may be configured to establish a communication interface with remote computing device 560. In some embodiments, the Trojan may provide information and data related to, and/or processed by, the device on which the Trojan is installed. For example, a user of laptop 555 may enter secure information via a keyboard of laptop 555, and a Trojan installed in laptop 555 may record keystroke data. In some instances, such data may be saved in a local cache and transmitted in discrete data packets. In some embodiments, the captured data may be transmitted via the established communication interface to remote computing device 560.

As another example, desktop 530 may send a file to be printed to multifunction device 535. A Trojan installed in desktop 530 and/or multifunction device 535 may retrieve contents of the transmitted or received file, and communicate the content to remote computing device 560. Also, for example, smart phone 550 may be used to capture content (e.g., video, still images, sound, etc.), and a Trojan installed in smart phone 550 may intercept such captured content and communicate the content to remote computing device 560.

### Example Computing Environment

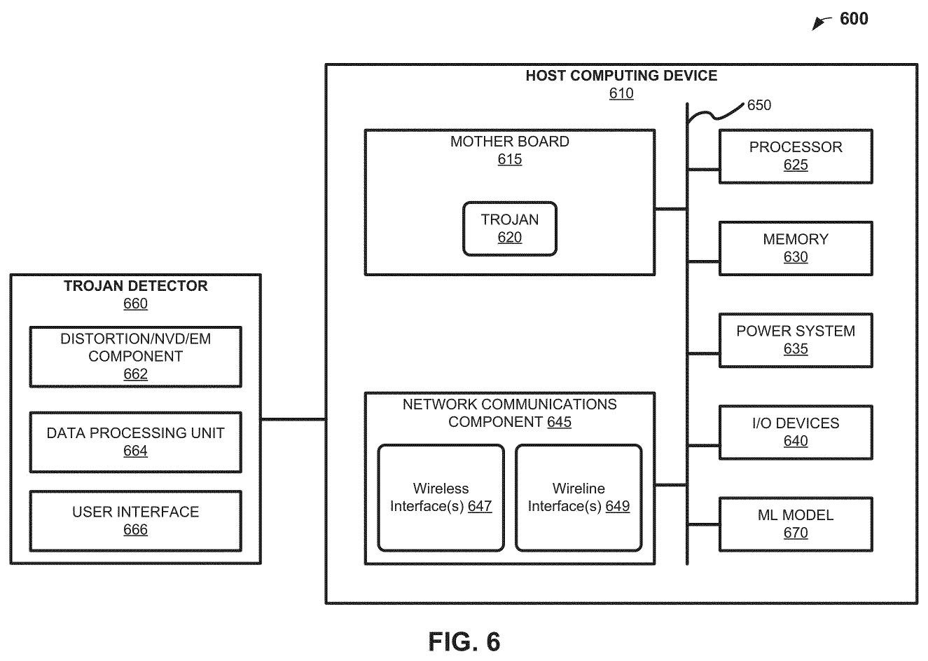

FIG. 6 is a block diagram of an example computing environment 600 for Trojan detection, in accordance with example embodiments. In particular, computing environment 600 shown in FIG. 6 can be configured to perform at least one function of and/or related to Trojan detection.

Computing environment 600 may include host computing device 610 (that is likely to be hosting a hostile hardware component, such as a Trojan), and Trojan detector 660. Host computing device 610 can include a mother board 615, one or more processors 625, memory 630, power system 635, input/output devices 640, and network communications component 645, all of which may be linked together via a system bus, network, or other connection mechanism 650. Host computing device 610 can be one or more of the devices described with reference to FIG. 5 (e.g., desktop 530, a multifunction device 535, a server 540, a handheld device 545, a smart phone 550, and/or a laptop 555).

Mother board 615 is a printed circuit board (PCB) that enables communication between various components of host computing device 610, such as, for example, one or more processors 625, memory 630, power system 635, input/output devices 640, and network communications component 645. Mother board 615 may itself comprise one or more microprocessors, memory, memory controllers, input/output controllers (including one or more input ports and one or more output ports), interface controllers, and so forth. In some embodiments, a Trojan 620 may be installed in mother board 615. Trojan 620 may be configured to be activated after host computing device 610 is assembled, and/or after host computing device 610 is delivered to an end user. In such embodiments, Trojan detection may be performed at different times to determine whether a hostile element is present in the computing device. Also, for example, if a Trojan is not detected at a first time, the PCB may be tested at a second time to determine if a Trojan has been activated after the first time.

One or more processors 625 can include one or more general purpose processors, and/or one or more special purpose processors (e.g., digital signal processors, graphics processing units (GPUs), application specific integrated circuits, etc.). One or more processors 625 can be configured to execute computer-readable instructions that are contained in memory 630 and/or other instructions as described herein.

Memory 630 can include one or more non-transitory computer-readable storage media that can be read and/or accessed by at least one of one or more processors 625. The one or more computer-readable storage media can include volatile and/or non-volatile storage components, such as optical, magnetic, organic or other memory or disc storage, which can be integrated in whole or in part with at least one of one or more processors 625. In some examples, memory 630 can be implemented using a single physical device (e.g., one optical, magnetic, organic or other memory or disc storage unit), while in other examples, memory 630 can be implemented using two or more physical devices.

Power system 635 can include one or more batteries and/or one or more external power interfaces for providing electrical power to host computing device 610. One or more external power interfaces of power system 635 can include one or more wired-power interfaces, such as a USB cable and/or a power cord, that enable wired electrical power connections to one or more power supplies that are external to host computing device 610.

Input/output devices 640 may include storage devices, a receiver, a transmitter, a speaker, a display, an image capturing component, an audio recording component, a user input device (e.g., a keyboard, a mouse, a microphone), and so forth. Although not shown in FIG. 6, one or more of I/O devices 640 may be a device external to host computing device 610. Such an external device may communicate with host computing device 610 via a wired or wireless connection, and such communication may be facilitated by an I/O interface of host computing device 610.

Network communications component 645 can include one or more devices that provide one or more wireless interfaces 647 and/or one or more wireline interfaces 649 that are configurable to communicate via a network. Wireless interface(s) 647 can include one or more wireless transmitters, receivers, and/or transceivers, such as a Bluetooth™ transceiver, a Wi-Fi™ transceiver, an LTE™ transceiver, and/or other type of wireless transceiver configurable to communicate via a wireless network. Wireline interface(s) 649 can include one or more wireline transmitters, receivers, and/or transceivers, such as an Ethernet transceiver, a Universal Serial Bus (USB) transceiver, or similar transceiver configurable to communicate via a physical connection to a wireline network.

Network communications component 645 can be configured to provide reliable, secured, and/or authenticated communications between various components. For each communication described herein, information for facilitating reliable communications (e.g., guaranteed message delivery) can be provided, perhaps as part of a message header and/or footer (e.g., packet/message sequencing information, encapsulation headers and/or footers, size/time information, and transmission verification information). Communications can be made secure (e.g., be encoded or encrypted) and/or decrypted/decoded using one or more cryptographic protocols and/or algorithms, such as, but not limited to, a secure sockets protocol such as Secure Sockets Layer (SSL), and/or Transport Layer Security (TLS).

Computing environment 600 can include Trojan detector 660. In some implementations, Trojan detector 660 can include distortion/NVD/EM component 662, data processing unit 664, and/or user interface 666. Distortion/NVD/EM component 662 can be configured to apply a distortion to host computing device 610. For example, distortion/NVD/EM component 662 can apply distortions including one or more of modifying a functioning of processor 625, exhausting a storage capacity of memory 630, changing a power configuration of power system 635, changing an amount of incoming or outgoing data from I/O devices 640, altering a configuration of network communications component 645, and/or overloading bus 650. Additional and/or alternate distortions may be applied. In some embodiments, distortion/NVD/EM component 662 can apply a NVD sensor, an EM probe, individually, or various combinations of one or more distortions, NVD sensor, and/or EM probe.

Data processing unit 664 can be configured to measure signals from host computing device 610. Generally, host computing device 610 may transmit a baseline signal during normal operations. Applying a distortion can upend assumed logic for Trojan 620, causing it to respond. In some implementations, Trojan detector 660 can receive signals from host computing device 610 under distortion, compare the received signals to a baseline data representative of the baseline signal, and upon detecting a deviation from the baseline, determine that Trojan 620 is likely to be present in host computing device 610.

Although distortion/NVD/EM component 662 and data processing unit 664 are shown as distinct components of Trojan detector 660, this is for illustrative purposes only. In some embodiments, distortion/NVD/EM component 662 and data processing unit 664 can be a single component. In some implementations, distortion/NVD/EM component 662 and data processing unit 664 can be housed in two separate physical devices.

In some embodiments, Trojan detector 660 can include user interface 666. User interface 666 can be configured to display an output of an analysis of data processing unit 664, display one or more alert messages, and interact with a user. For example, user interface 666 can be configured to send and/or receive data to and/or from user input devices such as a touch screen, a computer mouse, a keyboard, a keypad, a voice recognition module, and/or other similar devices. User interface 666 can also be configured to provide output to user display devices. User interface 666 can also be configured to generate audible outputs, such as voice commands, alert sounds, and so forth. In some examples, user interface 666 can be used to provide a graphical user interface (GUI) to provide an output from Trojan detector 660.

ML Model 670 can include machine learning algorithms to classify anomalies, detect patterns, determine device fingerprints, and so forth. As described herein, ML model 670 may include a deep neural network, a CNN, a CNN-LSTM, a GAN, a support vector machine, and so forth.

### Example Machine Learning Models

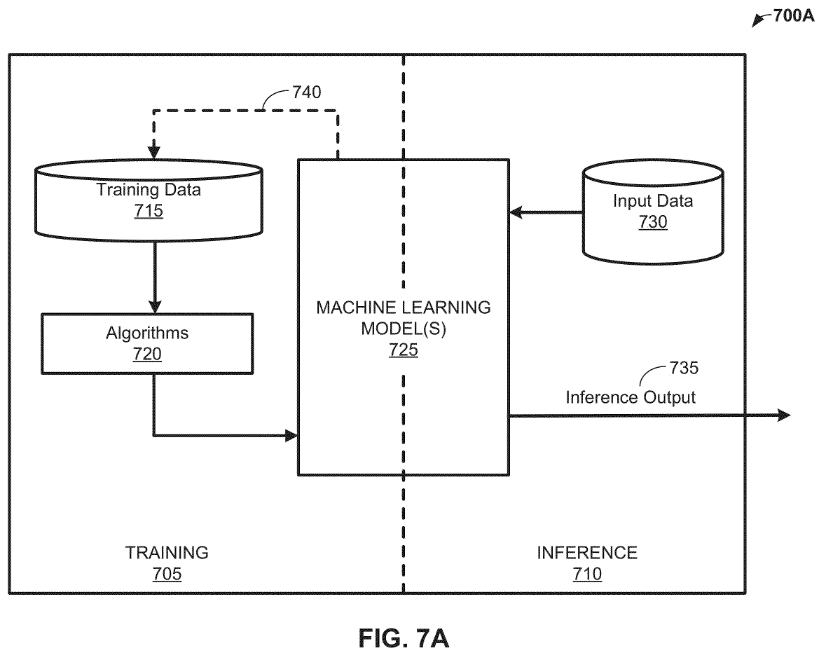

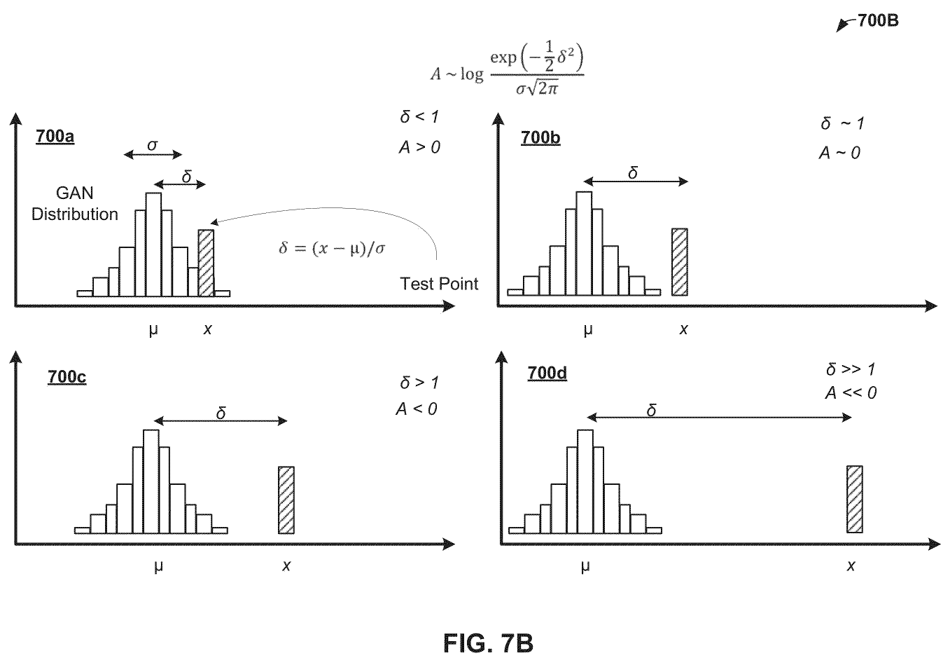

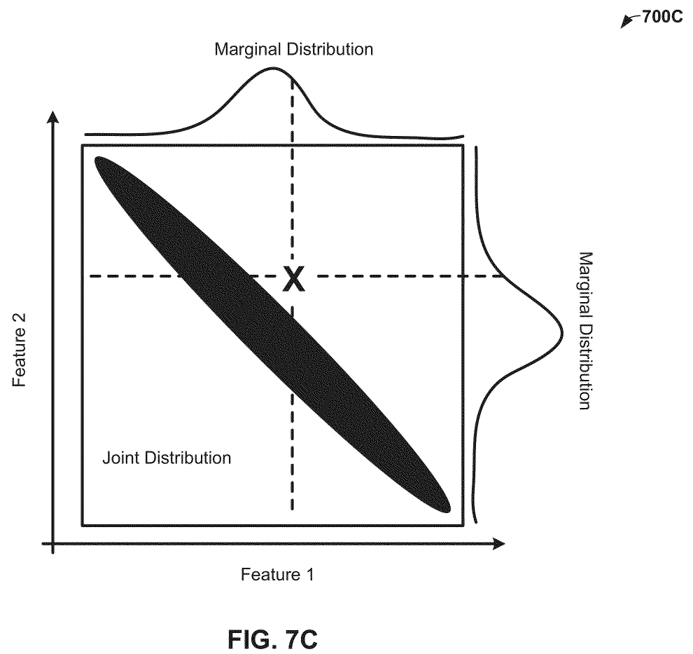

FIG. 7A shows a block diagram 700 depicting training and inference phases for an example machine learning model, in accordance with example embodiments. As described herein, one or more machine learning models may be trained and deployed to perform the tasks. For example, deep neural network 730 of FIG. 7A may include a trained neural network to generate a device fingerprint, detect an anomaly, and so forth. Trained models may be used for fingerprint generation, anomaly detection, and so forth.

Block diagram 700 includes a training phase 705 and an inference phase 710. Generally, machine learning models 725 are trained during the training phase 705 by using training data 715. In some embodiments, machine learning models may be trained by utilizing one or more machine learning algorithms 720 that are applied to training data 715 to recognize patterns in the input data 730 and output inferences 735. Training data 715, the one or more algorithms 720, or both, may depend on a particular machine learning model, its expected functionality, a desired precision, a desired efficiency, a desired accuracy, available computing resources, and so forth. During the inference phase 710, the trained machine learning models 725 receive input data 730 and generate predictions or an inference output 735 about input data 730. For example, deep neural network 730 may be trained to determine one or more device fingerprints associated with a device. In some embodiments, deep neural network 730 may be trained based on a type of device, a type of method to detect a Trojan (e.g., distortion, NVD sensor, and/or EM probe), and so forth.

In some embodiments, anomaly detection may be performed by a generative adversarial network (GAN). For example, the GAN may be applied to regenerate a statistical distribution of behavioral characteristics of a device. Subsequently, new data may be compared to the generated statistical distribution using a “log-probability” distance measure.

For example, an anomaly score may be determined by applying a distance measure between new samples and a statistical distribution of values generated by the GAN. For example, for scalar data and a model that is a random variable, repeated calls to the GAN may generate a normal distribution with a mean value µ, and a standard deviation σ. The probability p of a new signal x may be determined from a distribution:

$$p \left(x\right) = \frac{exp \left(- \frac{1}{2} {δ}^{2}\right)}{σ \sqrt{2 π}}$$

Where a dimensionless variable δ may be defined as δ = (x - µ)/σ. As a distance to a new point δ increases, the exponential may underflow, or be too small for precise evaluation. Accordingly, the underflow issue may be resolved by computing a log of the exponent to estimate an anomaly score A.

FIG. 7B illustrates anomaly scores 700B obtained using a GAN model, in accordance with example embodiments. As illustrated in graphs 700a and 700b, when the distance δ between the test point and the distribution is small, the exponential evaluates to a value close to one. However, as the distance δ of the new sample x increases (as illustrated in graphs 700c and 700d), exponential evaluates to a very small value and is likely to underflow (i.e., the value becomes very close to zero).

In some embodiments, to compute a distance measure, a sum of the exponential distances between the new sample x and 10,000 GAN generated samples may be computed. Each new measurement may be treated as a random variable. Accordingly, the anomaly score A tracks whether a new measurement is similar to a generated data point. Upon a determination that a new data point overlaps with a GAN generated data point, the anomaly score may be derived to a positive number. However, upon a determination that there is no match between the new data point and the GAN generated points, the anomaly score returns a negative number.

FIG. 7C illustrates a joint distribution 700C to compute anomaly scores, in accordance with example embodiments. To determine distances within a joint distribution, an L²-norm between an N-dimensional sample (e.g., with N features) and each generated data point may be determined. In FIG. 7C, N = 2 for illustrative purposes, and includes two features, Feature 1 and Feature 2. A marginal distribution for each feature may be determined, as illustrated along the respective axes, and a joint distribution may be computed based on the two (or N) marginal distributions. For example, a standard deviation σ_{N} can be computed from the geometric mean of N features as:

$${σ}_{N} = 2 ∗ \frac{\sqrt[N]{\left(\prod {σ}_{i}\right)}}{M}$$

Generally, the standard deviation may be divided by a number of generated samples M (e.g., M = 10,000). In some embodiments, an anomaly score A may be computed for a given sample x with a “logsumexp” function as:

$$A \left(x\right) = log {\sum }_{i} \frac{exp \left(- \frac{1}{2} ∥ {x}^{⌢} - {μ}^{⌢} {∥}^{2}\right)}{{σ}_{N} {}^{2}}$$

As described herein, inference output 735 may include a label associated with an anomaly (based on a trained classifier, such a support vector machine). Also, for example, inference output 735 may include a predicted classification and a predicted anomaly score. In some embodiments, inference output 735 may include the anomaly classification, a device fingerprint, and so forth. Also, for example, inference output 735 may include an output of a feature detection system.

Algorithms 720 may include, but are not limited to artificial neural networks (e.g., convolutional neural networks, recurrent neural networks, a Bayesian network, a hidden Markov model, a Markov decision process, a logistic regression function, a support vector machine, a statistical machine learning algorithm, and/or a heuristic machine learning system). Algorithms 720 may involve supervised, unsupervised, semi-supervised, and/or reinforcement learning techniques. Machine learning models 725 may involve deep learning networks, and/or convolutional neural networks, including, but not limited to, CNN, RNN-LSTM, GAN, and so forth, or any combination thereof. In some embodiments, machine learning models 725 may be updated based on the inference phase 710, and training data 715 may be updated via feedback loop 740.

In some embodiments, machine learning models 725 and/or algorithms 720 may be located within one computing device, or in a shared computing environment (e.g., computing environment 600). In some embodiments, machine learning models 725 and/or algorithms 720 may be a part of a distributed computing architecture, such as one or more cloud servers. Also, for example, machine learning models 725 and/or algorithms 720 may be located within an organization, such as a cybersecurity framework for an organization. In some embodiments, the training 705 of the one or more machine learning models 725 may be performed at a computing device that is different from a computing device where inference 710 is performed. Also, for example, input data 730 may be received at a first computing device, and provided to a second computing device that houses trained machine learning models 725. The second computing device may then apply machine learning models 725 to input data 730, and generate inference output 735. Subsequently, inference output 735 may be provided to the first computing device. Generally, one or more components of FIG. 7A may be available as a platform, as an application programming interface (API), an application-specific integrated circuit (ASIC), as a service (e.g., Software as a Service (SaaS), Machine Learning as a Service (MLaaS), Analytics as a Service (AnaaS), Platform as a Service (PaaS), Knowledge as a Service (KaaS), and so forth.

### Example Computer-Readable Medium

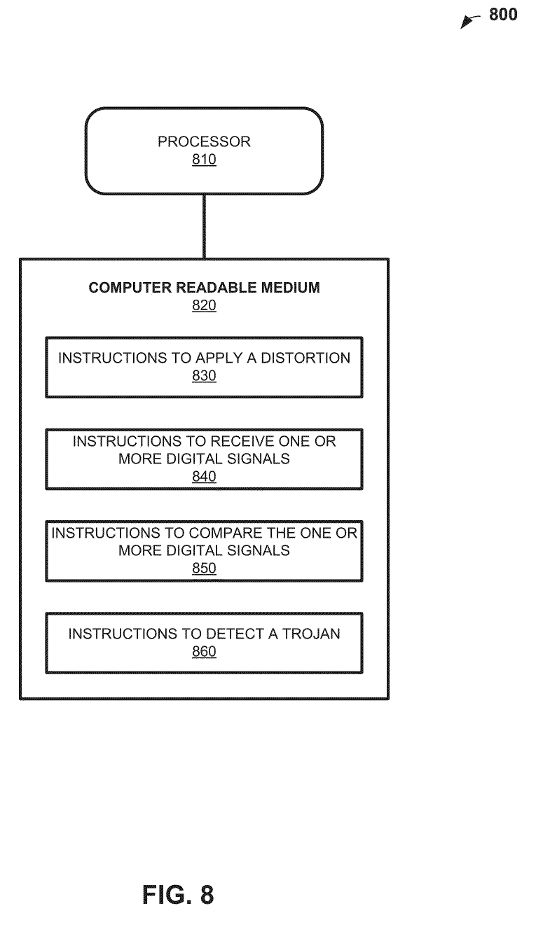

FIG. 8 is a block diagram of an example computing device 800 including non-transitory computer-readable medium storing executable code for a distortion-based detection system, in accordance with example embodiments.

The computing device 800 has processing circuitry, such as the illustrated processor 810, and computer readable medium 820 storing a set of instructions 830, 840, 850, and 860, that, when executed by the one or more processors, cause the computing device to perform operations. The computer readable medium 820 can, for example, include ROM, RAM, EEPROM, Flash 15 memory, a solid state drive, and/or discrete data register sets.

At 830, the operations may include applying, by a testing computing device, a distortion to a computing device under test. The distortion includes operating the computing device under test at a performance range of a computational resource that could cause the computing device under test to operate outside a normal range.

At 840, the operations may include receiving, by the testing computing device and in response to the applying of the distortion, one or more digital signals from the computing device under test.

At 850, the operations may also include comparing, by the testing computing device, the one or more digital signals to one or more baseline digital signals associated with the computing device under test.

At 860, the operations may additionally include detecting, based on the comparing, a presence of at least one anomalous element that could be indicative of a hostile element in the computing device under test.

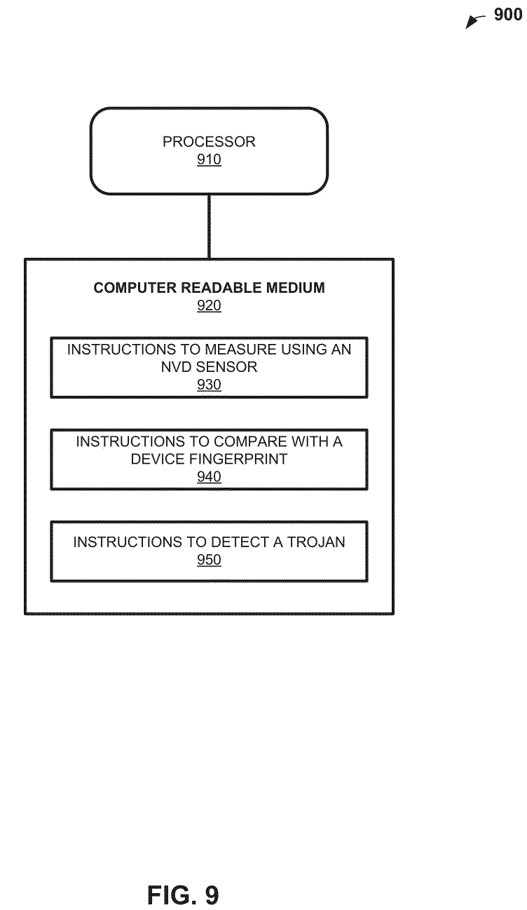

FIG. 9 is a block diagram of an example computing device 900 including non-transitory computer-readable medium storing executable code for a NVD sensor-based detection system, in accordance with example embodiments.

The computing device 900 has processing circuitry, such as the illustrated processor 910, and computer readable medium 920 storing a set of instructions 930, 940, and 950, that, when executed by the one or more processors, cause the computing device to perform operations. The computer readable medium 920 can, for example, include ROM, RAM, EEPROM, Flash 15 memory, a solid state drive, and/or discrete data register sets.

At 930, the operations may include measuring, by a nitrogen-vacancy diamond (NVD) sensor, a digital signal transmitted by a region of a printed circuit board (PCB) of a computing device under test for a presence of at least one anomalous element that could be indicative of a hostile element in the PCB.

At 940, the operations may include comparing, by a testing computing device, the digital signal to a device fingerprint associated with the computing device under test.

At 950, the operations may also include detecting, based on the comparing and by the testing computing device, the presence of the at least one anomalous element in the region of the PCB.

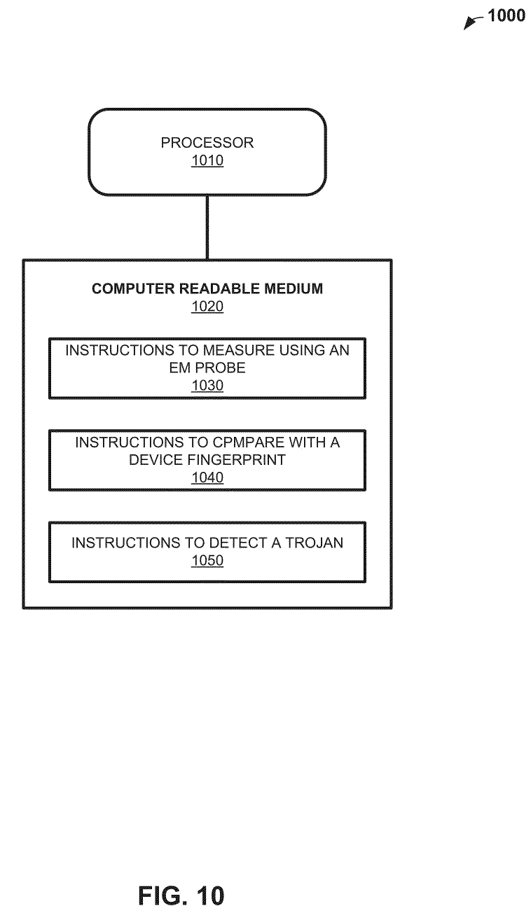

FIG. 10 is a block diagram of an example computing device 1000 including non-transitory computer-readable medium storing executable code for an electromagnetic (EM) probe-based detection system, in accordance with example embodiments.

The computing device 1000 has processing circuitry, such as the illustrated processor 1010, and computer readable medium 1020 storing a set of instructions 1030, 1040, and 1050, that, when executed by the one or more processors, cause the computing device to perform operations. The computer readable medium 1020 can, for example, include ROM, RAM, EEPROM, Flash 15 memory, a solid state drive, and/or discrete data register sets.

At 1030, the operations may include measuring, by an electromagnetic (EM) probe, an EM radiation transmitted by a region of a printed circuit board (PCB) of a computing device under test for a presence of at least one anomalous element that could be indicative of a hostile element in the PCB.

At 1040, the operations may include comparing, by a testing computing device, the EM radiation to a device fingerprint associated with the computing device under test.

At 1050, the operations may also include detecting, based on the comparing and by the testing computing device, the presence of the at least one anomalous element in the region of the PCB.

### Example Method of Operation

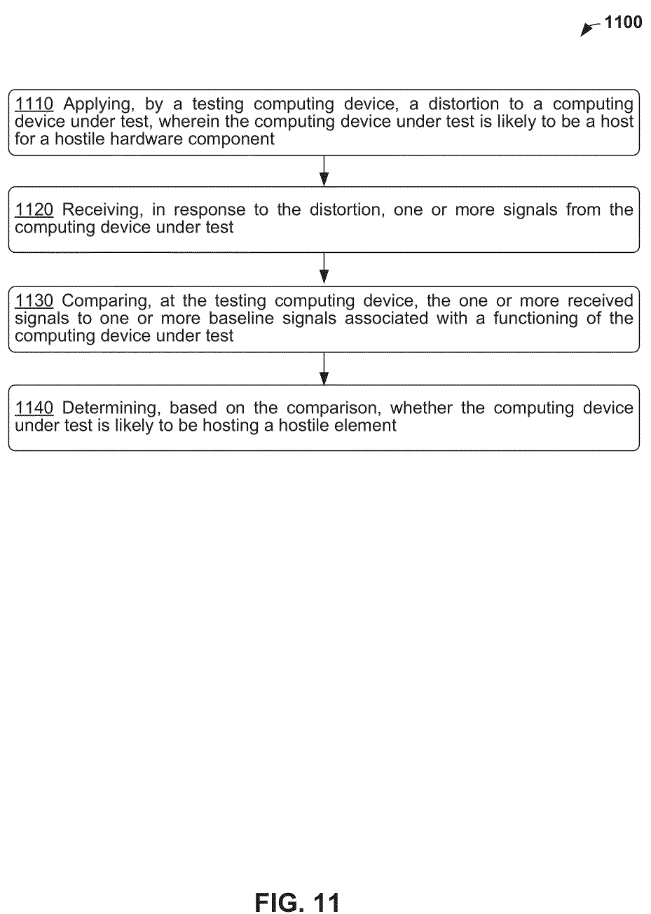

FIG. 11 illustrates a method 1100 for a Trojan detection system, in accordance with example embodiments. Method 1100 may include various blocks or steps. The blocks or steps may be carried out individually or in combination. The blocks or steps may be carried out in any order and/or in series or in parallel. Further, blocks or steps may be omitted or added to method 1100.

The blocks of method 1100 may be carried out by various elements of computing environment 600 as illustrated and described in reference to FIG. 6.

Block 1110 includes applying, via a testing computing device, a distortion to a computing device under test, wherein the computing device under test is likely to be a host for a hostile hardware component.

Block 1120 includes receiving, in response to the distortion, one or more signals from the computing device under test.

Block 1130 includes comparing, at the testing computing device, the one or more received signals to one or more baseline signals associated with a functioning of the computing device under test.

Block 1140 includes determining, based on the comparison, whether the computing device under test is likely to be hosting a hostile element.

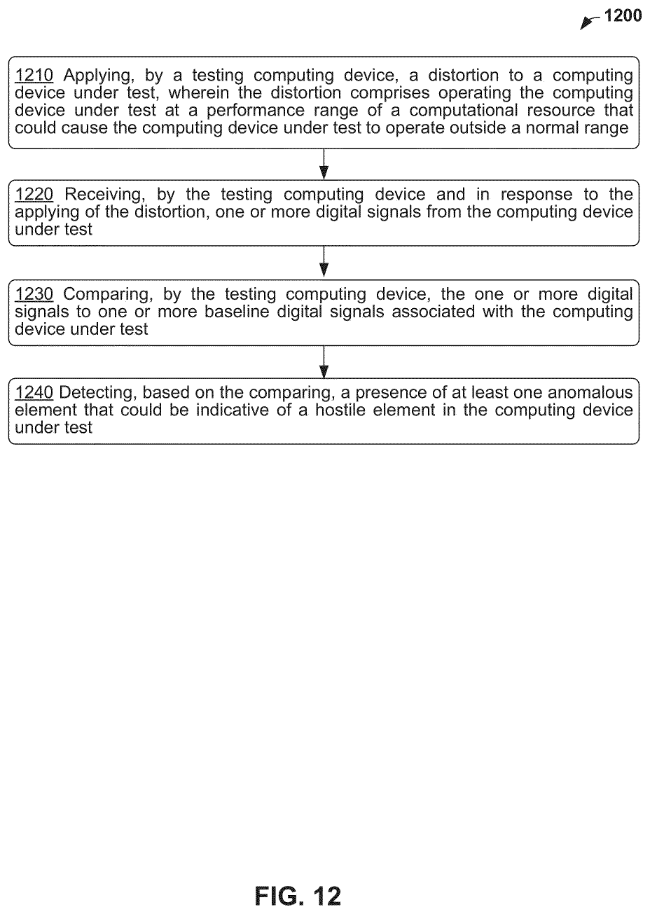

FIG. 12 illustrates a method 1200 for a distortion-based detection system, in accordance with example embodiments. Method 1200 may include various blocks or steps. The blocks or steps may be carried out individually or in combination. The blocks or steps may be carried out in any order and/or in series or in parallel. Further, blocks or steps may be omitted or added to method 1200.

The blocks of method 1200 may be carried out by various elements of computing environment 600 as illustrated and described in reference to FIG. 6.

Block 1210 includes applying, by a testing computing device, a distortion to a computing device under test, wherein the distortion comprises operating the computing device under test at a performance range of a computational resource that could cause the computing device under test to operate outside a normal range.

Block 1220 includes receiving, by the testing computing device and in response to the applying of the distortion, one or more digital signals from the computing device under test.

Block 1230 includes comparing, by the testing computing device, the one or more digital signals to one or more baseline digital signals associated with the computing device under test.

Block 1240 includes detecting, based on the comparing, a presence of at least one anomalous element that could be indicative of a hostile element in the computing device under test.

In some embodiments, the applying of the distortion involves determining the performance capacity of the computational resource. Such embodiments also involve configuring the distortion to achieve the performance capacity. The receiving of the one or more digital signals further includes detecting a behavior of the computational resource at the performance capacity.

In some embodiments, the receiving of the one or more digital signals involves receiving the one or more digital signals by one or more of a nitrogen-vacancy diamond (NVD) sensor or an electromagnetic (EM) probe.

In some embodiments, the comparing of the one or more digital signals to the one or more baseline digital signals involves detecting a change in a thermal measurement by detecting, by the NVD sensor, a shift in a photoluminescence central frequency toward a lower frequency. The shift is indicative of a change in the thermal measurement to a higher temperature.

Some embodiments involve generating, by the NVD sensor, a temperature map of a printed circuit board (PCB). The detecting of the presence of the at least one anomalous element involves comparing the generated map with a density map for a flow of current in the PCB.

Some embodiments involve determining the one or more baseline digital signals by applying the distortion to a control device. For example, a known device without hostile elements can be measured by applying one or more of distortions, EM probes, or NVD testing, and the measured values may be used to establish a baseline digital signal. Such baseline digital signals may be determined for various devices, and/or components within devices. Machine learning models may be used to detect patterns of baseline behavior.

Some embodiments involve determining the one or more baseline digital signals by utilizing one or more of a nitrogen-vacancy diamond (NVD) sensor or an electromagnetic (EM) probe.

In some embodiments, the comparing of the one or more digital signals to the one or more baseline digital signals involves detecting a change in one or more of a resistance, a capacitance, an integrated circuit (IC) design, a trace impedance, or a thermal measurement.

In some embodiments, the detecting of the presence of the at least one anomalous element is performed by a neural network. Such embodiments may involve determining the one or more baseline digital signals by the neural network.

In some embodiments, the computational resource may be a memory resource. The operating of the computing device under test at the performance capacity involves exhausting an available memory resource of the computing device under test.

In some embodiments, the computational resource may be one of an internal network, an internal clock, a bus, a processing unit, a power resource, an operating system, a task manager, a port, an external hardware device communicatively linked to the computing device under test, or a network capability.

In some embodiments, the computational resource may be a baseboard management controller (BMC). The applying of the distortion involves applying the distortion to a network interface card (NIC). The NIC supports a control channel for the BMC via a network controller sideband interface (NC-SI) protocol.

In some embodiments, the distortion includes one or more of resetting a memory arbiter, disabling a memory arbiter, modifying one or more parameters of a coalescing engine, fingerprinting a buffer operation of a direct memory access (DMA), or modifying a parameter of a watchdog timer.

In some embodiments, the hostile element may be a hardware component.

In some embodiments, the hostile element may be configured to perform one or more operations including: (i) opening a back door to the one or more computational resources, (ii) misappropriating data from the computing device under test, (iii) revealing system behavior for the computing device under test, (iv) revealing network characteristics associated with the computing device under test, (v) collecting data associated with the computing device under test, (vi) transmitting data associated with the computing device under test to a hostile actor, (vii) establishing a communication channel with a hostile actor, (viii) communicating with a hostile actor, or (ix) disrupting the one or more computational resources.

Some embodiments involve, subsequent to the detecting of the presence of the at least one anomalous element, generating an alert notification indicating the presence of the at least one anomalous element.

Some embodiments involve, subsequent to the detecting of the presence of the at least one anomalous element, performing one or more operations on the computing device under test to mitigate the presence of the hostile element.

Some embodiments involve applying, by the testing computing device, a second distortion to the computing device under test at another time. Such embodiments involve determining whether a second hostile element is present in the computing device under test. Such embodiments also involve detecting that the second hostile element is present in the computing device under test.

Some embodiments involve applying, by the testing computing device, a second distortion to the computing device under test at a first time. Such embodiments involve determining whether a second hostile element is present in the computing device under test at the first time. Such embodiments also involve, upon a determination that the second hostile element is not present in the computing device under test at the first time, repeating, at a second time after the first time, the applying of the second distortion.

In some embodiments, the testing computing device may be a robotic device configured to automatically apply the distortion.

In some embodiments, the computing device under test may include a plurality of servers.

Some embodiments involve determining a confidence level for the computing device under test, wherein the confidence level is indicative of a hostile element detected in the computing device under test. The determining of the confidence level may involve applying respective weights to each of the at least one anomalous elements, wherein the respective weights are based on a type of hostile element. The confidence level may be a weighted average of the number of anomalous elements. Such embodiments may also involve determining, based on the confidence level for the computing device under test, one or more of a frequency of applying a distortion or a type of distortion to be applied to the computing device under test.

In some embodiments, the computing device under test may be configured with a Byzantine circuit comprising a predetermined distortion pattern to cause a synchronization skew, and wherein the detecting of the presence of the at least one anomalous element comprises one or more of detecting a malfunction of the computational resource or an error in a processing task performed by the computational resource.

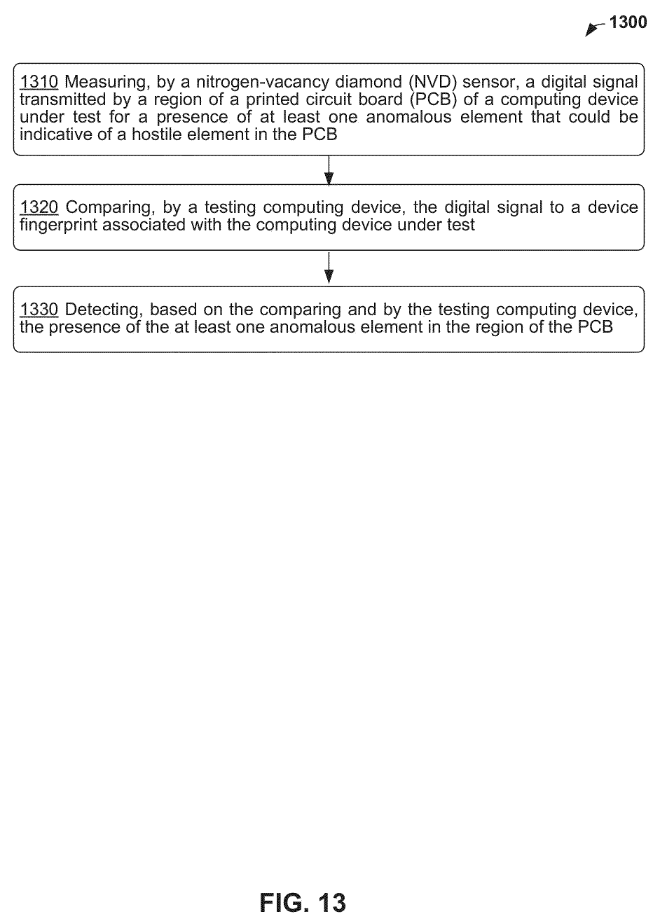

FIG. 13 illustrates a method 1300 for a NVD sensor-based detection system, in accordance with example embodiments. Method 1300 may include various blocks or steps. The blocks or steps may be carried out individually or in combination. The blocks or steps may be carried out in any order and/or in series or in parallel. Further, blocks or steps may be omitted or added to method 1300.

The blocks of method 1300 may be carried out by various elements of computing environment 600 as illustrated and described in reference to FIG. 6.

Block 1310 includes measuring, by a nitrogen-vacancy diamond (NVD) sensor, a digital signal transmitted by a region of a printed circuit board (PCB) of a computing device under test for a presence of at least one anomalous element that could be indicative of a hostile element in the PCB.

Block 1320 includes comparing, by a testing computing device, the digital signal to a device fingerprint associated with the computing device under test.

Block 1330 includes detecting, based on the comparing and by the testing computing device, the presence of the at least one anomalous element in the region of the PCB.

In some embodiments, the comparing of the digital signal to the device fingerprint associated with the computing device under test involves detecting a change in one or more of a resistance, a capacitance, an integrated circuit (IC) design, a trace impedance, or a thermal measurement.

In some embodiments, the detecting of the change in the thermal measurement involves detecting, by the NVD sensor, a shift in a photoluminescence central frequency toward a lower frequency, wherein the shift is indicative of a change in the thermal measurement to a higher temperature. Such embodiments involve generating, by the NVD sensor, a temperature map of the PCB. The detecting of the presence of the at least one anomalous element involves comparing the generated map with a density map for a flow of current in the PCB.

In some embodiments, the detecting of the presence of the at least one anomalous element may be performed by a neural network. In some embodiments, the neural network is a recurrent neural network with a long short-term memory (RNN-LSTM). In some embodiments, the neural network is a generative adversarial network (GAN).

Some embodiments involve determining the device fingerprint by the neural network.

Some embodiments involve applying, by the testing computing device, a distortion to the computing device under test, wherein the distortion comprises operating the computing device under test at a performance range of a computational resource that could cause the computing device under test to operate outside a normal range. The measuring of the digital signal involves measuring the digital signal in response to the applying of the distortion.

Some embodiments involve measuring, by an electromagnetic (EM) probe, an EM radiation transmitted by the PCB. The detecting of the presence of the at least one anomalous element is based on the measured EM radiation.

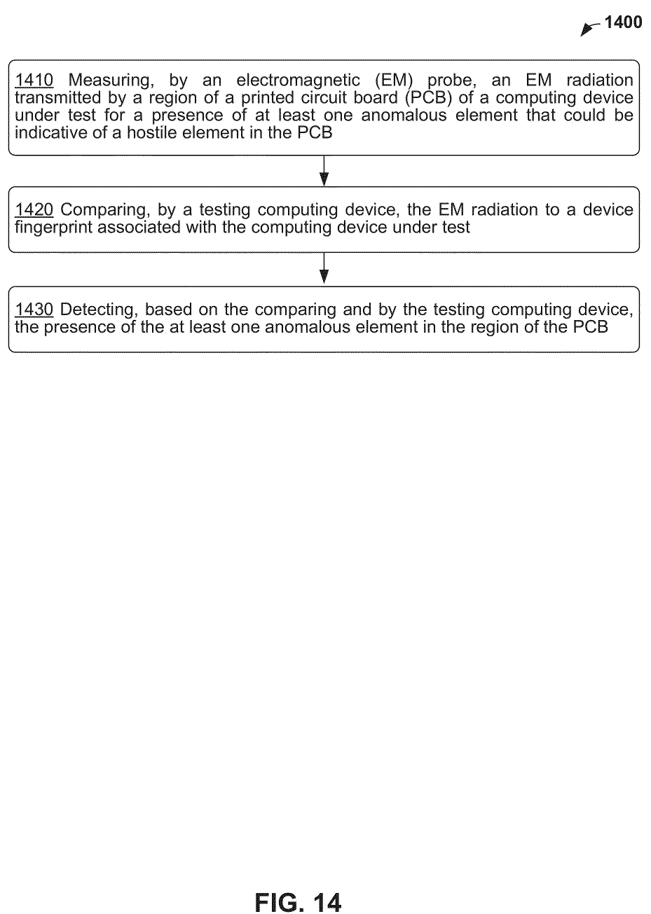

FIG. 14 illustrates a method 1400 for an electromagnetic (EM) probe, in accordance with example embodiments. Method 1400 may include various blocks or steps. The blocks or steps may be carried out individually or in combination. The blocks or steps may be carried out in any order and/or in series or in parallel. Further, blocks or steps may be omitted or added to method 1400.

The blocks of method 1400 may be carried out by various elements of computing environment 600 as illustrated and described in reference to FIG. 6.

Block 1410 includes measuring, by an electromagnetic (EM) probe, an EM radiation transmitted by a region of a printed circuit board (PCB) of a computing device under test for a presence of at least one anomalous element that could be indicative of a hostile element in the PCB.

Block 1420 includes comparing, by a testing computing device, the EM radiation to a device fingerprint associated with the computing device under test.

Block 1430 includes detecting, based on the comparing and by the testing computing device, the presence of the at least one anomalous element in the region of the PCB.

In some embodiments, the comparing of the EM radiation to the device fingerprint associated with the computing device under test involves detecting a change in one or more of a resistance, a capacitance, an integrated circuit (IC) design, or a trace impedance.

In some embodiments, the detecting of the presence of the at least one anomalous element may be performed by a neural network. Such embodiments involve determining the device fingerprint by the neural network.

Some embodiments involve applying, by the testing computing device, a distortion to the computing device under test, wherein the distortion includes operating the computing device under test at a performance range of a computational resource that could cause the computing device under test to operate outside a normal range. The measuring of the EM radiation involves measuring the EM radiation in response to the applying of the distortion.

Some embodiments involve measuring, by a nitrogen-vacancy diamond (NVD) sensor, a digital signal transmitted by the PCB. The detecting of the presence of the at least one anomalous element is based on the measured digital signal.

The particular arrangements shown in the Figures should not be viewed as limiting. It should be understood that other embodiments may include more or less of each element shown in a given Figure. Further, some of the illustrated elements may be combined or omitted. Yet further, an illustrative embodiment may include elements that are not illustrated in the Figures.

A step or block that represents a processing of information and/or comparison of signals can correspond to circuitry that can be configured to perform the specific logical functions of a herein-described method or technique. Alternatively or additionally, a step or block that represents a processing of information and/or comparison of signals can correspond to a module, a segment, or a portion of program code (including related data). The program code can include one or more instructions executable by a processor for implementing specific logical functions or actions in the method or technique. The program code and/or related data can be stored on any type of computer readable medium such as a storage device including a disk, hard drive, or other storage medium.

The computer readable medium can also include non-transitory computer readable media such as computer-readable media that store data for short periods of time like register memory, processor cache, and random access memory (RAM). The computer readable media can also include non-transitory computer readable media that store program code and/or data for longer periods of time. Thus, the computer readable media may include secondary or persistent long term storage, like read only memory (ROM), optical or magnetic disks, compact-disc read only memory (CD-ROM), for example. The computer readable media can also be any other volatile or non-volatile storage systems. A computer readable medium can be considered a computer readable storage medium, for example, or a tangible storage device.

Note, an application described herein includes but is not limited to software applications, mobile applications, and programs that are part of an operating system application. Some portions of this description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. These algorithms can be written in a number of different software programming languages such as C, C++, HTTP, Java, or other similar languages. Also, an algorithm can be implemented with lines of code in software, configured logic gates in hardware, or a combination of both. In an embodiment, the logic consists of electronic circuits that follow the rules of Boolean Logic, software that contain patterns of instructions, or any combination of both. A component may be implemented in hardware electronic components, software components, and a combination of both.

Generally, application includes programs, routines, objects, widgets, plug-ins, and other similar structures that perform particular tasks or implement particular abstract data types. Those skilled in the art can implement the description and/or figures herein as computer-executable instructions, which can be embodied on any form of computing machine-readable media discussed herein.

Many functions performed by electronic hardware components can be duplicated by software emulation. Thus, a software program written to accomplish those same functions can emulate the functionality of the hardware components in input-output circuitry.

While various examples and embodiments have been disclosed, other examples and embodiments will be apparent to those skilled in the art. The various disclosed examples and embodiments are for purposes of illustration and are not intended to be limiting, with the true scope being indicated by the following claims.

What is claimed is:

1. A computer-implemented method, comprising:
applying, by a testing computing device, a distortion to a computing device under test, wherein the distortion comprises operating the computing device under test at a performance range of a computational resource that could cause the computing device under test to operate outside a normal range;
receiving, by the testing computing device and in response to the applying of the distortion, one or more digital signals from the computing device under test;
comparing, by the testing computing device, the one or more digital signals to one or more baseline digital signals associated with the computing device under test; and
detecting, based on the comparing, a presence of at least one anomalous element that could be indicative of a hostile element in the computing device under test.

2. The computer-implemented method of claim 1, wherein the applying of the distortion comprises:
determining a performance capacity of the computational resource; and
configuring the distortion to achieve the performance capacity, and
wherein the receiving of the one or more digital signals further comprises detecting a behavior of the computational resource at the performance capacity.

3. The computer-implemented method of claim 1, wherein the receiving of the one or more digital signals comprises receiving the one or more digital signals by one or more of a nitrogen-vacancy diamond (NVD) sensor or an electromagnetic (EM) probe.

4. The computer-implemented method of claim 3, wherein the comparing of the one or more digital signals to the one or more baseline digital signals comprises detecting a change in a thermal measurement by detecting, by the NVD sensor, a shift in a photoluminescence central frequency toward a lower frequency, wherein the shift is indicative of a change in the thermal measurement to a higher temperature.

5. The computer-implemented method of claim 4, further comprising:
generating, by the NVD sensor, a temperature map of a printed circuit board (PCB), and
wherein the detecting of the presence of the at least one anomalous element comprises comparing the generated map with a density map for a flow of current in the PCB.

6. The computer-implemented method of claim 1, further comprising:
determining the one or more baseline digital signals by applying the distortion to a control device.

7. The computer-implemented method of claim 1, further comprising:
determining the one or more baseline digital signals by utilizing one or more of a nitrogen-vacancy diamond (NVD) sensor or an electromagnetic (EM) probe.

8. The computer-implemented method of claim 7, wherein the comparing of the one or more digital signals to the one or more baseline digital signals comprises detecting a change in one or more of a resistance, a capacitance, an integrated circuit (IC) design, a trace impedance, or a thermal measurement.

9. The computer-implemented method of claim 1, wherein the detecting of the presence of the at least one anomalous element is performed by a neural network.

10. The computer-implemented method of claim 9, further comprising:
determining the one or more baseline digital signals by the neural network.

11. The computer-implemented method of claim 2, wherein the computational resource is a memory resource, and wherein the operating of the computing device under test at the performance capacity comprises exhausting an available memory resource of the computing device under test.

12. The computer-implemented method of claim 1, wherein the computational resource is one of an internal network, an internal clock, a bus, a processing unit, a power resource, an operating system, a task manager, a port, an external hardware device communicatively linked to the computing device under test, or a network capability.

13. The computer-implemented method of claim 1, wherein the computational resource is a baseboard management controller (BMC), and wherein applying of the distortion comprises applying the distortion to a network interface card (NIC), wherein the NIC supports a control channel for the BMC via a network controller sideband interface (NC-SI) protocol.

14. The computer-implemented method of claim 1, wherein the distortion comprises one or more of resetting a memory arbiter, disabling a memory arbiter, modifying one or more parameters of a coalescing engine, fingerprinting a buffer operation of a direct memory access (DMA), or modifying a parameter of a watchdog timer.

15. The computer-implemented method of claim 1, wherein the hostile element is a hardware component.

16. The computer-implemented method of claim 1, wherein the hostile element is configured to perform one or more operations comprising: (i) opening a back door to the one or more computational resources, (ii) misappropriating data from the computing device under test, (iii) revealing system behavior for the computing device under test, (iv) revealing network characteristics associated with the computing device under test, (v) collecting data associated with the computing device under test, (vi) transmitting data associated with the computing device under test to a hostile actor, (vii) establishing a communication channel with a hostile actor, (viii) communicating with a hostile actor, or (ix) disrupting the one or more computational resources.

17. The computer-implemented method of claim 1, further comprising:
subsequent to the detecting of the presence of the at least one anomalous element, generating an alert notification indicating the presence of the at least one anomalous element.

18. The computer-implemented method of claim 1, further comprising:
subsequent to the detecting of the presence of the at least one anomalous element, performing one or more operations on the computing device under test to mitigate the presence of the hostile element.

19. The computer-implemented method of claim 1, further comprising:
applying, by the testing computing device, a second distortion to the computing device under test at another time;
determining whether a second hostile element is present in the computing device under test; and
detecting that the second hostile element is present in the computing device under test.

20. The computer-implemented method of claim 1, further comprising:
applying, by the testing computing device, a second distortion to the computing device under test at a first time;
determining whether a second hostile element is present in the computing device under test at the first time; and
upon a determination that the second hostile element is not present in the computing device under test at the first time, repeating, at a second time after the first time, the applying of the second distortion.

21. The computer-implemented method of claim 1, wherein the testing computing device is a robotic device configured to automatically apply the distortion.

22. The computer-implemented method of claim 1, wherein the computing device under test comprises a plurality of servers.

23. The computer-implemented method of claim 1, further comprising:
determining a confidence level for the computing device under test, wherein the confidence level is indicative of a hostile element detected in the computing device under test.

24. The computer-implemented method of claim 23, wherein the determining of the confidence level further comprises:
applying respective weights to each of the at least one anomalous element, wherein the respective weights are based on a type of hostile element, and
wherein the confidence level is a weighted average of the number of anomalous components.

25. The computer-implemented method of claim 23, further comprising:
determining, based on the confidence level for the computing device under test, one or more of a frequency of applying a distortion or a type of distortion to be applied to the computing device under test.

26. The computer-implemented method of claim 1, the computing device under test having been configured with a Byzantine circuit comprising a predetermined distortion pattern to cause a synchronization skew, and wherein the detecting of the presence of the at least one anomalous element comprises one or more of detecting a malfunction of the computational resource or an error in a processing task performed by the computational resource.

27. A computer-implemented method, comprising:
measuring, by a nitrogen-vacancy diamond (NVD) sensor, a digital signal transmitted by a region of a printed circuit board (PCB) of a computing device under test for a presence of at least one anomalous element that could be indicative of a hostile element in the PCB;
comparing, by a testing computing device, the digital signal to a device fingerprint associated with the computing device under test; and
detecting, based on the comparing and by the testing computing device, the presence of the at least one anomalous element in the region of the PCB.

28. The computer-implemented method of claim 27, wherein the comparing of the digital signal to the device fingerprint associated with the computing device under test comprises detecting a change in one or more of a resistance, a capacitance, an integrated circuit (IC) design, a trace impedance, or a thermal measurement.

29. The computer-implemented method of claim 28, wherein the detecting of the change in the thermal measurement comprises detecting, by the NVD sensor, a shift in a photoluminescence central frequency toward a lower frequency, wherein the shift is indicative of a change in the thermal measurement to a higher temperature.

30. The computer-implemented method of claim 29, further comprising:
generating, by the NVD sensor, a temperature map of the PCB, and
wherein the detecting of the presence of the at least one anomalous element comprises comparing the generated map with a density map for a flow of current in the PCB.

31. The computer-implemented method of claim 27, wherein the detecting of the presence of the at least one anomalous element is performed by a neural network.

32. The computer-implemented method of claim 31, further comprising:
determining the device fingerprint by the neural network.

33. The computer-implemented method of claim 27, further comprising:
applying, by the testing computing device, a distortion to the computing device under test, wherein the distortion comprises operating the computing device under test at a performance range of a computational resource that could cause the computing device under test to operate outside a normal range, and
wherein the measuring of the digital signal comprises measuring the digital signal in response to the applying of the distortion.

34. The computer-implemented method of claim 27, further comprising:
measuring, by an electromagnetic (EM) probe, an EM radiation transmitted by the PCB, and
wherein the detecting of the presence of the at least one anomalous element is based on the measured EM radiation.

35. A computer-implemented method, comprising:
measuring, by an electromagnetic (EM) probe, an EM radiation transmitted by a region of a printed circuit board (PCB) of a computing device under test for a presence of at least one anomalous element that could be indicative of a hostile element in the PCB;
comparing, by a testing computing device, the EM radiation to a device fingerprint associated with the computing device under test; and
detecting, based on the comparing and by the testing computing device, the presence of the at least one anomalous element in the region of the PCB.

36. The computer-implemented method of claim 35, wherein the comparing of the EM radiation to the device fingerprint associated with the computing device under test comprises detecting a change in one or more of a resistance, a capacitance, an integrated circuit (IC) design, or a trace impedance.

37. The computer-implemented method of claim 35, wherein the detecting of the presence of the at least one anomalous element is performed by a neural network.

38. The computer-implemented method of claim 37, further comprising:
determining the device fingerprint by the neural network.

39. The computer-implemented method of claim 35, further comprising:
applying, by the testing computing device, a distortion to the computing device under test, wherein the distortion comprises operating the computing device under test at a performance range of a computational resource that could cause the computing device under test to operate outside a normal range, and
wherein the measuring of the EM radiation comprises measuring the EM radiation in response to the applying of the distortion.

40. The computer-implemented method of claim 35, further comprising:
measuring, by a nitrogen-vacancy diamond (NVD) sensor, a digital signal transmitted by the PCB, and
wherein the detecting of the presence of the at least one anomalous element is based on the measured digital signal.
